(19) United States
(12) Patent Application Publication
(10) Pub. No.: US 2026/0345420 A1
(43) Pub. Date: Nov. 5, 2026

(54) WEARABLE DEVICE HAVING JOINT ANGLE CORRECTION FUNCTION, AND METHOD FOR OPERATING WEARABLE DEVICE

(71) Applicant: SAMSUNG ELECTRONICS CO., LTD., Suwon-si (KR)

(72) Inventors: Jungpil YU, Suwon-si (KR); Sukhoon SONG, Suwon-si (KR)

(21) Appl. No.: 19/704,656

(22) Filed: Jun. 11, 2026

Related U.S. Application Data
(63) Continuation of application No. PCT/KR2024/017463, filed on Nov. 7, 2024.

(30) Foreign Application Priority Data
Dec. 29, 2023 (KR) 10-2023-0197069
Apr. 19, 2024 (KR) 10-2024-0052688

(51) Int. Cl. A61H 3/00

(52) U.S. Cl. CPC A61H 3/00; A61H 2003/007; A61H 2201/1207; A61H 2201/165; A61H 2201/5007; A61H 2201/5069

(57) ABSTRACT

A wearable device having a joint angle correction function, and/or a method for operating the wearable device. An example method for operating the wearable device may include: using sensor data acquired from a sensor of the wearable device, so as to determine the number of steps of a user wearing the wearable device; tracking an angle range for a user joint angle on the basis of the determined number of steps and the user joint angle measured by the wearable device; determining a joint angle correction value on the basis of the tracked angle range; determining a corrected joint angle on the basis of the measured joint angle and the determined joint angle correction value; and controlling the torque output of the wearable device on the basis of the corrected joint angle.

### CROSS-REFERENCE TO RELATED APPLICATIONS

This application is a continuation application of International Application No. PCT/KR2024/017463, filed on Nov. 7, 2024, in the Korean Intellectual Property Receiving Office, and claiming priority to KR Application No. 10-2023-0197069 filed Dec. 29, 2023 and KR Application No. 10-2024-0052688 filed Apr. 19, 2024, the disclosures of which are all hereby incorporated by reference herein in their entireties.

### TECHNICAL FIELD

Certain example embodiments may relate to a wearable device having a joint angle calibration function and/or an operating method of a wearable device.

### BACKGROUND

In general, a walking assistance device refers to a mechanism or device that helps a patient, who cannot walk on his own due to various diseases, accidents, and the like, to perform walking exercises or other exercise for rehabilitation treatment for example, and/or a mechanism or device that may be used for such exercises. With the recent intensifying aging societies, a growing number of people experience inconvenience in walking or have difficulty in normal walking due to malfunctioning joint issues, and there is increasing interest in walking assistance devices. A walking assistance device may be configured to be mounted on the body of a user, for example, to assist the user with walking by providing a necessary muscular strength and to induce the user to walk in a normal walking pattern. A walking assistance device may assist the user with various leg exercises (e.g., one or more of power walking, jogging, stair climbing, lunging, and stretching).

### SUMMARY

An operating method of a wearable device according to an example embodiment may include determining a number of steps of a user wearing the wearable device using sensor data obtained from a sensor of the wearable device, based on the determined number of steps and a joint angle of the user measured by the wearable device, tracking an angle range of the joint angle of the user, determining a joint angle calibration value based on the tracked angle range, determining a calibrated joint angle based on the measured joint angle and the determined joint angle calibration value, and controlling a torque output of the wearable device based on the calibrated joint angle.

Awearable device according to an example embodiment may include a driving module including a motor and/or circuitry, a torque transmission frame configured to transmit torque generated by the motor to a leg of a user, a sensor including an angle sensor configured to measure a joint angle of the user corresponding to an angle of the torque transmission frame, and one or more processors, comprising processing circuitry, configured to calibrate the joint angle and control the motor based on the calibrated joint angle. The one or more processors may be configured (individually and/or collectively) to determine a number of steps of the user wearing the wearable device using sensor data obtained from the sensor, based on the determined number of steps and a joint angle of the user measured by the wearable device, track an angle range of the joint angle of the user, determine a joint angle calibration value based on the tracked angle range, determine a calibrated joint angle based on the measured joint angle and the determined joint angle calibration value, and control a torque output of the motor based on the calibrated joint angle.

### BRIEF DESCRIPTION OF DRAWINGS

These and/or other aspects, features and advantages will become apparent and more readily understood from the following description of exemplary embodiments, taken in conjunction with the accompanying drawings.

FIG. 1 is a diagram illustrating an overview of a wearable device worn on a body of a user according to various example embodiments.

FIG. 2 is a diagram illustrating an exercise assistance system according to various example embodiments.

FIG. 3 is a rear schematic view of a wearable device according to various example embodiments.

FIG. 4 is a left side view of a wearable device according to various example embodiments.

FIG. 5 is a diagram illustrating components of a wearable device according to various example embodiments.

FIG. 6 is a diagram illustrating an interaction between a wearable device and an electronic device according to various example embodiments.

FIG. 7 is a diagram illustrating components of an electronic device according to various example embodiments.

FIG. 8 is a diagram illustrating a system for performing calibration of a joint angle and controlling torque of a wearable device based on the calibrated joint angles according to various example embodiments.

FIG. 9 is a diagram illustrating a joint angle measured by a wearable device according to various example embodiments.

FIGS. 10 and 11 are diagrams illustrating occurrence of a distortion in a joint angle measured by a wearable device.

FIG. 12 is a diagram illustrating an operation of determining the number of steps according to various example embodiments.

FIG. 13 is a diagram illustrating an operation of tracking an angle range for a joint angle according to various example embodiments.

FIG. 14 is a diagram illustrating an operation of determining a joint angle calibration value according to various example embodiments.

FIG. 15 is a diagram illustrating components of a joint angle calibrator according to various example embodiments.

FIG. 16 is a diagram illustrating components of a joint angle calibrator according to various example embodiments.

FIGS. 17 and 18 are flowcharts illustrating operations of an operating method of a wearable device according to an example embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

As used herein, the singular forms “a,” “an,” and “the” are intended to include the plural forms as well, unless the context clearly indicates otherwise. It will be understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto will be omitted.

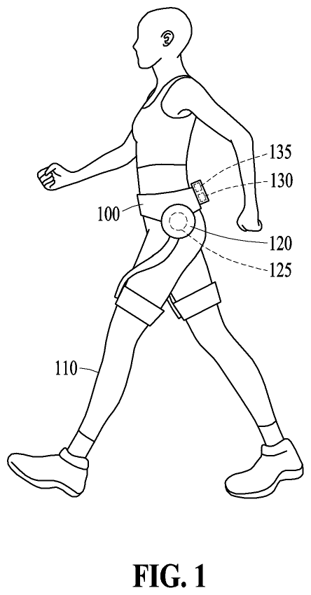

FIG. 1 is a diagram illustrating an overview of a wearable device worn on a body of a user according to various embodiments.

Referring to FIG. 1, in an embodiment, a wearable device 100 may be a device worn on a body of a user 110 to assist the user 110 in walking, exercising, and/or working. The wearable device 100 may be used to measure a physical ability (e.g., a walking ability, an exercise ability, or an exercise posture) of the user 110. In embodiments, the term “wearable device” may be replaced with “wearable robot,” “walking assistance device,” or “exercise assistance device”. The user 110 may be a person who walks, exercises, or performs a task while wearing the wearable device 100.

The wearable device 100 may be worn on the body (e.g., a lower body (the legs, ankles, knees, etc.) and/or an upper body (the torso, arms, wrists, etc.)) of the user 110 to apply an external force such as an assistance force and/or a resistance force to a body motion of the user 110. The assistance force may be a force assisting the body motion of the user 110, which is applied in the same direction as a direction of the body motion of the user 110. The resistance force may be a force applied in a direction opposite to the body motion direction of the user 110, the force hindering a body motion of the user 110. The term “resistive force” may also be referred to as an “exercise load”.

In an embodiment, the wearable device 100 may operate in a walking assistance mode for assisting the user 110 in walking. In the walking assistance mode, the wearable device 100 may assist the user 110 in walking by applying an assistance force generated by a driving module 120 of the wearable device 100 to the body of the user 110. The wearable device 100 may enable the user 110 to walk independently or to walk for a long time by providing a force required for the user 110 to walk, thereby expanding the walking ability of the user 110. The wearable device 100 may help improve the walking of a user having an abnormal walking habit or gait posture.

In an embodiment, the wearable device 100 may operate in an exercise assistance mode for enhancing the effect of exercise of the user 110 or providing various exercise experiences to the user 110. The exercise assistance mode may include a resistance mode and an assistance mode. The resistance mode of the exercise assistance mode may be a mode for hindering a body motion of the user 110 or providing resistance to a body motion of the user 110 by applying a resistance force generated by the driving module 120 to the body of the user 110. When the wearable device 100 is a hip-type wearable device that is worn on the waist (or pelvis) and legs (e.g., thighs) of the user 110, the wearable device 100 may provide an exercise load to a leg motion of the user 110 while being worn on the legs in the resistance mode, thereby enhancing the effect of exercise on the legs of the user 110. The assistance mode of the exercise assistance mode may be a mode for applying an assistance force to assist with the body motion of the user 110 to the body of the user 110. In the assistance mode, an assistance force in the same direction as a body motion may be provided to the user 110. For example, when a person with a disability or an elderly person wears the wearable device 100 to exercise, the wearable device 100 may provide an assistance force to assist a body motion. In the assistance mode, the wearable device 100 may provide a force in the same direction as a direction of the leg motion of the user 110, and the user 110 may exercise with a small force through the force provided by the wearable device 100. In an exercise program performed using the wearable device 100, the resistance mode and the assistance mode may be combined and operated. For example, the wearable device 100 may provide an assistance force and a resistance force in combination for each exercise session or time interval in such a manner of providing an assistance force in one exercise session and providing a resistance force in another exercise session. In the exercise assistance mode, various exercise programs may be operated depending on the exercise purpose and/or a physical ability of the user 110. The exercise program may be exercise content that the user 110 performs using the wearable device 100 and may include, for example, cardio exercises, strength training, posture balancing, or any combination thereof. The types of exercise programs are not limited thereto and may be various. The resistance mode and the assistance mode may be alternately activated appropriately depending on an exercise program performed by the wearable device 100, and a target exercise speed that is suitable for an appropriate physical condition (e.g., a heart rate) of the user 110 may be guided to the user during the exercise of the user 110.

In an embodiment, the wearable device 100 may operate in a physical ability measurement mode for measuring a physical ability of the user 110. The wearable device 100 may measure motion information of the user 110 using a sensor (e.g., an angle sensor 125 and an inertial measurement unit (IMU) 135) provided in the wearable device 100 during the walking and/or exercise of the user 110 and may assess the physical ability of the user 110 based on the measured motion information. For example, a walking index (e.g., the number of steps, the total walking distance, or a stride length) or an exercise ability indicator (e.g., muscular strength, exercise endurance, or posture balance) of the user 110 may be estimated through the motion information of the user 110 measured by the wearable device 100.

In some embodiments, the description is provided based on an example of the hip-type wearable device 100 as shown in FIG. 1. However, the embodiments are not limited thereto. As described above, the wearable device 100 may also be worn on other body parts (e.g., upper arms, lower arms, hands, calves, or feet) other than the waist and thighs. The shape and configuration of the wearable device 100 may vary depending on the body part on which the wearable device 100 is worn.

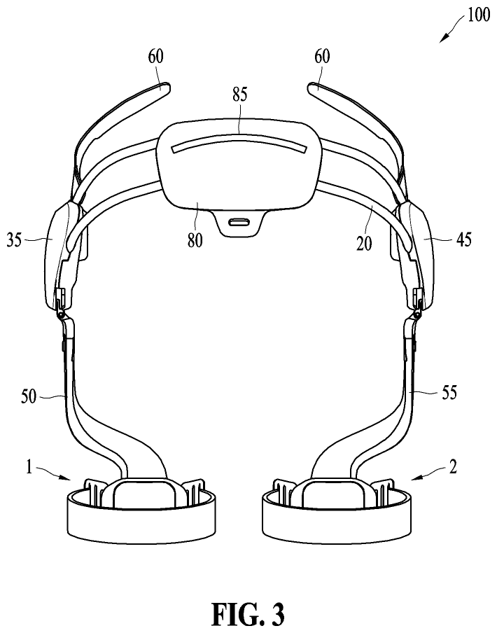

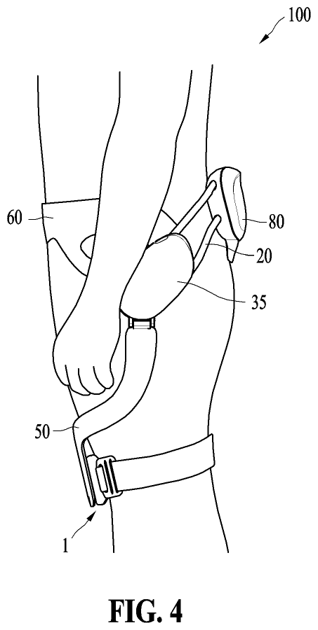

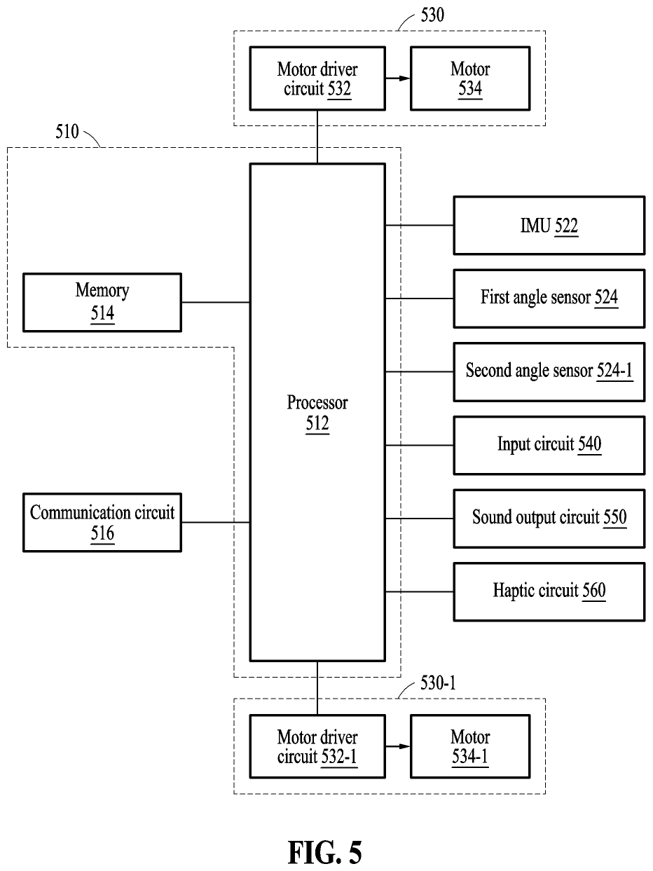

The wearable device 100 may include a support frame (e.g., a waist support frame 20 of FIGS. 3 and 4) configured to support the body of the user 110 when the wearable device 100 is worn on the body of the user 110, the driving module 120 (e.g., a first driving module 45 and a second driving module 35 of FIG. 3) configured to generate torque to be applied to the legs of the user 110, a torque transmission frame (e.g., a first torque transmission frame 55 and a second torque transmission frame 50 of FIG. 3) configured to transmit the torque generated by the driving module 120 to the legs of the user 110, a sensor circuit including one or more sensors configured to obtain sensor data including motion information about a body motion (e.g., a leg motion and an upper body motion) of the user 110, and a control circuit 130 (e.g., a control circuit 510 of FIG. 5) configured to control an operation of the wearable device 100.

In an embodiment, the wearable device 100 may include the angle sensor 125 and the IMU 135. The angle sensor 125 may measure a rotation angle of the torque transmission frame of the wearable device 100 corresponding to a hip joint angle of the user 110. The angle sensor 125 may include, for example, an encoder and/or a Hall sensor. In an embodiment, the angle sensor 125 may be disposed adjacent to a position where a motor included in the driving module 120 is connected to the torque transmission frame. The IMU 135 may include an acceleration sensor and/or an angular velocity sensor, and may measure a change in acceleration and/or angular velocity according to a motion of the user 110. The IMU 135 may measure, for example, a motion value of a waist support frame (e.g., the waist support frame 20 of FIG. 3) or a base body (e.g., a base body 80 of FIG. 3) of the wearable device 100. The motion value of the waist support frame or the base body measured by the IMU 135 may correspond to a waist motion value (or an upper body motion value) of the user 110.

In an embodiment, the control circuit 130 and the IMU 135 may be arranged within the base body (e.g., the base body 80 of FIG. 3) of the wearable device 100. The base body may be on the waist of the user 110 while the user 110 is wearing the wearable device 100. The base body may be formed on or attached to an outer side of the waist support frame of the wearable device 100. The base body may support the lumbar region of the user 110.

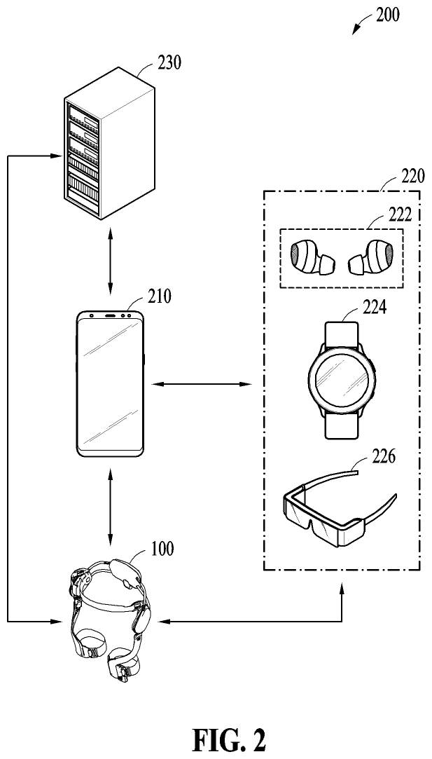

FIG. 2 is a diagram illustrating an exercise assistance system according to various embodiments.

Referring to FIG. 2, an exercise assistance system 200 may include the wearable device 100, an electronic device 210, another wearable device 220, and a server 230. At least one (e.g., the electronic device 210, the other wearable device 220, or the server 230) of the devices excluding the wearable device 100 may be omitted from the exercise assistance system 200, or at least one device (e.g., a dedicated controller for the wearable device 100) may be added to the exercise assistance system 200.

In an embodiment, the wearable device 100 may be worn on a body of a user in the walking assistance mode to assist a motion of the user. For example, the wearable device 100 may be worn on the legs of the user to help the user in walking by generating an assistance force for assisting a leg motion of the user.

In an embodiment, the wearable device 100 may generate and apply a resistance force for hindering a body motion of the user and/or an assistance force for assisting a body motion of the user to the body of the user to enhance an effect of the user's exercise in the exercise assistance mode. In the exercise assistance mode, the user may select an exercise program (e.g., cardio exercise such as power walking and outdoor walking, strength training such as squats, split lunges, dumbbell squats, and lunge and knee ups, a stretching exercise, a posture balancing exercise, or any combination thereof) that the user desires to conduct using the wearable device 100 through the electronic device 210 and/or an exercise intensity applied to the exercise program. The wearable device 100 may control a driving module (e.g., the driving module 120 of FIG. 1) of the wearable device 100 based on the exercise program and/or exercise intensity selected by the user. The wearable device 100 may adjust the strength of the resistance force and/or the assistance force generated by the driving module based on the exercise intensity selected by the user. The wearable device 100 may control the driving module to generate a resistance force corresponding to the exercise intensity selected by the user. As the exercise intensity increases, the strength of the resistance force applied to the user may increase.

The wearable device 100 may transmit sensor data measured by a sensor (e.g., the angle sensor 125 or the IMU 135 of FIG. 1) to the electronic device 210, and receive a control signal to control an operation of the wearable device 100 from the electronic device 210.

The electronic device 210 may communicate with the wearable device 100 via wireless communication (e.g., Bluetooth communication) or wired communication, may remotely control the wearable device 100, or may provide state information on a state (e.g., a booting state, a charging state, an exercise program operation state, or an error state) of the wearable device 100 to the user. The electronic device 210 may recommend an exercise program using the wearable device 100 to the user and may analyze an exercise performed by the user. The electronic device 210 may receive sensor data obtained by the sensor of the wearable device 100 from the wearable device 100, and estimate a current exercise state, an exercise result, an exercise posture, and/or a physical ability of the user based on the received sensor data. “Based on” as used herein covers based at least on. The electronic device 210 may provide the user with the estimated current exercise state, exercise result, exercise posture, and/or physical ability of the user through a graphical user interface (GUI).

In an embodiment, the user may execute a program (e.g., an application) on the electronic device 210 to control the wearable device 100, and adjust an operation or a setting value (e.g., the magnitude of torque output from a motor of a driving module, the volume of audio output from a sound output circuit (e.g., a sound output circuit 550 of FIG. 5, or the brightness of a lighting unit (e.g., a lighting unit 85 of FIG. 3) of the wearable device 100 through the corresponding program. The program executed by the electronic device 210 may provide the GUI for an interaction with the user. The electronic device 210 may include various types of devices. For example, the electronic device 210 may include a portable communication device (e.g., a smartphone), a computer device, a portable multimedia device, or a home appliance (e.g., a television, an audio device, or a projector device), but is not limited thereto.

According to an embodiment, the electronic device 210 may be connected to the server 230 using short-range wireless communication or cellular communication. The server 230 may receive user profile information of the user who uses the wearable device 100 from the electronic device 210 and store and manage the received user profile information. The user profile information may include, for example, information about at least one of the name, age, gender, height, weight, medical history, or body mass index (BMI). The server 230 may receive exercise history information about an exercise performed by the user from the electronic device 210 and store and manage the received exercise history information. The server 230 may provide the electronic device 210 with various exercise programs or physical ability measurement programs to be provided to the user. In an embodiment, the server 230 may be connected to the wearable device 100. The server 230 may receive, from the wearable device 100, the sensor data measured by the wearable device 100 and transmit, to the wearable device 100, a control signal for controlling an operation of the wearable device 100 and/or data related to the exercise program. In an embodiment, the server 230 may be a cloud server.

According to an embodiment, the wearable device 100 and/or the electronic device 210 may be connected to the other wearable devices 220. Exercise result information, physical ability information, and/or exercise posture assessment information of the user that are determined by the electronic device 210 may be transmitted to the other wearable device 220 and provided to the user through the other wearable device 220. State information of the wearable device 100 may also be transmitted to the other wearable device 220 and provided to the user through the other wearable device 220. In an embodiment, the wearable device 100, the electronic device 210, and the other wearable device 220 may be connected to each other through wireless communication (e.g., Bluetooth communication or Wi-Fi communication). The other wearable device 220 may be, for example, wireless earphones 222, a smartwatch (or a watch-type wearable device) 224, or smartglasses (a wearable device in the type of glasses or goggles) 226, but is not limited thereto.

In an embodiment, the wireless earphones 222 may be wirelessly connected to the electronic device 210 and/or the wearable device 100 and may output a guiding voice, music, and/or sound effect related to the exercise program. The wireless earphones 222 may provide information related to the exercise program (e.g., introduction of the exercise program or a remaining exercise time) to the user or inquire about a selection of the user through the guiding voice. The wireless earphones 222 may include a microphone, and the microphone may receive a voice input from the user. The voice input received through the microphone may be transmitted to the electronic device 210, and voice recognition for the voice input may be performed by the electronic device 210.

In an embodiment, the smartwatch 224 may include a biometric sensor (e.g., a heart rate sensor or an electromyography sensor) configured to measure a biosignal, including heart rate information of the user, and transmit the biosignal measured by the biometric sensor to the electronic device 210 and/or the wearable device 100. For example, the electronic device 210 may estimate the heart rate information (e.g., the current heart rate, the maximum heart rate, and the average heart rate) and/or electromyography information of the user based on the biosignal received from the smartwatch 224, and provide the user with the estimated heart rate information and/or electromyography information. The heart rate information and/or the electromyography information may be used to determine the haptic intensity of haptic feedback provided through the wearable device 100.

In an embodiment, the smartwatch 224 may include an IMU configured to measure motion information of the user and/or a position sensor configured to measure position information of the user, and transmit the motion information and/or position information of the user to the electronic device 210 and/or the wearable device 100. The smartwatch 224 may include a communication circuit (e.g., a short-range communication circuit) for communicating with another device (e.g., the electronic device 210 or the wearable device 100). In an embodiment, the smartwatch 224 may provide an interface related to an exercise program through a display. The interface related to the exercise program may be implemented through a separate application installed on the smartwatch 224. The user may also control the wearable device 100 through the smartwatch 224.

In an embodiment, the smartglasses 226 may provide information to the user through a display in the form of glasses. For example, the smartglasses 226 may output information about the current exercise speed, a target exercise speed, the currently achieved exercise amount, the exercise time, and the biometric information, through the display in an exercise mode. In addition, the smartglasses 226 may output a screen for guiding the user with an exercise path.

FIG. 3 is a rear schematic view of a wearable device according to various embodiments. FIG. 4 is a left side view of a wearable device according to various embodiments.

Referring to FIGS. 3 and 4, the wearable device 100, according to an embodiment, may include the base body 80, the waist support frame 20, the driving modules 35 and 45, the torque transmission frames 50 and 55, the thigh fasteners 1 and 2, and the waist fastener 60. The base body 80 may include a lighting unit 85. In an embodiment, at least one (e.g., the lighting unit 85) of the components described above may be omitted from the wearable device 100, or one or more other components may be added to the wearable device 100.

The base body 80 may be positioned on the lumbar region or abdomen of a user when the user wears the wearable device 100. In an embodiment, the base body 80 may be worn on the lumbar region of the user to provide cushioning to the waist of the user and support the waist of the user. The base body 80 may be above a hip of the user when the user wears the wearable device 100 so that the wearable device 100 may not slip downward due to gravity. The base body 80 may distribute a portion of a weight of the wearable device 100 to the lower back of the user while the user is wearing the wearable device 100. The base body 80 may be connected to the waist support frame 20. Waist support frame connecting elements (not shown) to be connected to the waist support frame 20 may be provided at both end portions of the base body 80.

In an embodiment, the lighting unit 85 may be provided on the outer surface of the base body 80. The lighting unit 85 may include a light source (e.g., a light-emitting diode (LED)). The lighting unit 85 may emit light in response to a control of a processor (not shown) (e.g., a processor 512 of FIG. 5) of the wearable device 100. In some embodiments, the lighting unit 85 may be controlled to provide (or output) visual feedback corresponding to the state of the wearable device 100 through the lighting unit 85.

In an embodiment, a display (not shown) may be provided on the outer surface of the base body 80. The display may provide a screen for various pieces of visual information related to the wearable device 100 (e.g., state information of the wearable device 100) and a user interface (UI).

The waist support frame 20 may support a body part (e.g., the waist) of the user when the wearable device 100 is worn on the body of the user. The waist support frame 20 may extend from both end portions of the base body 80. The lumbar region of the user may be accommodated inside the waist support frame 20. The waist support frame 20 may include at least one rigid body beam. Each beam may be in a curved shape having a preset curvature to enclose the lumbar region of the user. The waist fastener 60 may be connected to an end portion of the waist support frame 20. The first driving module 45 and the second driving module 35 may be directly or indirectly connected to the waist support frame 20.

In an embodiment, a processor, a memory (e.g., a memory 514 of FIG. 5), an IMU (e.g., the IMU 135 of FIG. 1 or an IMU 522 of FIG. 5), a communication circuit (e.g., a communication circuit 516 of FIG. 5), a sound output circuit (e.g., the sound output circuit 550 of FIG. 5), and a battery (not shown) may be disposed in the base body 80. The base body 80 may protect the components inside the base body 80. The processor may generate a control signal for controlling the operation of the wearable device 100. The processor may control a motor (or an actuator) of each of the first driving module 45 and the second driving module 35 configured to generate torque based on electrical energy stored in the battery.

In an embodiment, the wearable device 100 may include one or more sensors. The wearable device 100 may include one or more sensors configured to obtain sensor data including motion information of the user and/or motion information of the components of the wearable device 100. For example, the one or more sensors may include an IMU (e.g., the IMU 135 of FIG. 1 or the IMU 522 of FIG. 5) configured to measure an upper body motion value of the user or a motion value of the waist support frame 20 and/or an angle sensor (e.g., the angle sensor 125 of FIG. 1 or a first angle sensor 524 and a second angle sensor 524-1 of FIG. 5) configured to measure a hip joint angle value of the user or an motion value of the torque transmission frame 50 or 55, but are not limited thereto. For example, the one or more sensors may further include at least one of a position sensor, a torque sensor, a pressure sensor, a temperature sensor, a biosignal sensor (e.g., a heart rate sensor or an electromyography sensor), a distance sensor, or a proximity sensor.

The waist fastener 60 may be connected, directly or indirectly, to the waist support frame 20 to fasten the waist support frame 20 to the waist of the user. The waist fastener 60 may include, for example, a pair of belts.

The first driving module 45 and the second driving module 35 may generate an external force (or torque) to be applied to the body of the user based on the control signal generated by the processor. For example, the first driving module 45 and the second driving module 35 may generate an assistance force or a resistance force applied to the legs of the user. In an embodiment, the first driving module 45 may be disposed at a position corresponding to the right hip joint of the user, and the second driving module 35 may be disposed at a position corresponding to the left hip joint of the user. The first driving module 45 may include a first actuator and a first joint member and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving power from the battery. When the motor is driven as the power is supplied thereto, the motor may generate a force (an assistance force) for assisting a body motion of the user or a force (a resistance force) for hindering a body motion of the user. In an embodiment, the processor may adjust the strength and direction of the force generated by the motor by adjusting a voltage and/or a current supplied to the motor.

In an embodiment, the first joint member and the second joint member may receive power from the first actuator and the second actuator, respectively, and may apply an external force to the body of the user based on the received power. In an embodiment, the first joint member and the second joint member may be disposed at positions corresponding to the joints of the user, respectively. One side of the first joint member may be directly or indirectly connected to the first actuator, and the other side of the first joint member may be directly or indirectly connected to the first torque transmission frame 55. The first joint member may be rotated by the power received from the first actuator. An encoder or a Hall sensor that may operate as an angle sensor to measure a rotation angle (corresponding to a joint angle of the user) of the first joint member or the first torque transmission frame 55 may disposed on one side of the first joint member. One side of the second joint member may be connected to the second actuator, and the other side of the second joint member may be connected to the second torque transmission frame 50. The second joint member may be rotated by the power received from the second actuator. An encoder or a Hall sensor that may operate as an angle sensor to measure a rotation angle of the second joint member or the second torque transmission frame 50 may be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, the embodiments are not limited thereto, and an actuator and a joint member may share a rotation axis. In an embodiment, each actuator may be spaced apart from a corresponding joint member. In this case, the driving module 35 or 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, when the wearable device 100 is worn on the legs of the user, the first torque transmission frame 55 and the second torque transmission frame 50 may transmit torque generated by the first driving module 45 and the second driving module 35 to the body (e.g., the legs) of the user, respectively. The transmitted torque may act as an external force applied to the motions of the legs of the user. Respective end portions of the first torque transmission frame 55 and the second torque transmission frame 50 may be directly or indirectly connected to the joint member and rotate. As the other end portions of the first torque transmission frame 55 and the second torque transmission frame 50 are directly or indirectly connected to the first thigh fastener 2 and the second thigh fastener 1, the first torque transmission frame 5 and the second torque transmission frame 50 may transmit the torque generated by the first driving module 45 and the second driving module 35 to the user's thighs while supporting the user's thighs. For example, the first torque transmission frame 55 and the second torque transmission frame 50 may push or pull the thighs of the user. The first torque transmission frame 55 and the second torque transmission frame 50 may extend in a longitudinal direction of the thighs of the user or may be bent and enclose at least some portions of the circumferences of the thighs of the user. The first torque transmission frame 55 may be a torque transmission frame for transmitting torque to the right leg of the user, and the second torque transmission frame 50 may be a torque transmission frame for transmitting torque to the left leg of the user.

The first thigh fastening portion 2 and the second thigh fastening portion 1 may be directly or indirectly connected to the first torque transmission frame 55 and the second torque transmission frame 50, respectively, and fasten the wearable device 100 to the legs (specifically, thighs) of the user. The first thigh fastener 2 may be a thigh fastener for fastening the wearable device 100 to the right thigh of the user, and the second thigh fastener 1 may be a thigh fastener for fastening the wearable device 100 to the left thigh of the user.

In an embodiment, the first thigh fastener 2 may include a first cover, a first fastening frame, and a first strap, and the second thigh fastener 1 may include a second cover, a second fastening frame, and a second strap. The first cover and the second cover may apply torque generated by the first driving module 45 and the second driving module 35 to the thighs of the user, respectively. For example, the first cover and the second cover may be respectively disposed on respective sides of the thighs of the user and may push or pull the thighs of the user. The first cover and the second cover may be arranged in circumferential directions of the thighs of the user. The first cover and the second cover may extend to both sides from the other end portions of the first torque transmission frame 55 and the second torque transmission frame 50, and may include curved surfaces corresponding to the thighs of the user. The respective ends of the first cover and the second cover may be directly or indirectly connected to the first fastening frame and the second fastening frame. The other ends of the first cover and the second cover may be directly or indirectly connected to the first strap and the second strap.

For example, the first fastening frame and the second fastening frame may be disposed to enclose at least some portions of the circumferences of the thighs of the user, thereby preventing or reducing chances of the thighs of the user from being separated from the wearable device 100. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIG. 5 is a diagram illustrating components of a wearable device according to various embodiments.

Referring to FIG. 5, the wearable device 100 may include a control circuit 510, a communication circuit 516, one or more sensors (e.g., an IM 522, a first angle sensor 524, and a second angle sensor 524-1), driving modules 530 and 530-1, an input circuit 540, a sound output circuit 550 including a speaker, and a haptic circuit 560.

The driving module 530 may include a motor 534 and a motor driver circuit 532 for driving the motor 534, and the driving module 530-1 may include a motor 534-1 and a motor driver circuit 532-1 for driving the motor 534-1. Although the embodiment of FIG. 5 shows two driving modules, this is merely an example, and one driving module or three or more driving modules may be provided. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3.

The one or more sensors may include one or more sensors configured to obtain sensor data (or sensed values). The one or more sensors may transmit the acquired sensor data to the control circuit 510. The one or more sensors may include, for example, the IMU 522, the first angle sensor 524, and/or the second angle sensor 524-1. Each of the sensors may be provided in plurality, and a portion of the sensors may be omitted.

The IMU 522 may measure a motion value of the body of the user. The IMU 522 may sense X-axis, Y-axis, and Z-axis accelerations and X-axis, Y-axis, and Z-axis angular velocities according to a motion of the user. The IMU 522 may measure, for example, an upper body motion value of the user. The upper body motion value of the user may correspond to a motion value of a waist support frame (e.g., the waist support frame 20 of FIGS. 3 and 4) of the wearable device 100. In an embodiment, the IMU 522 may be disposed on a printed circuit board (PCB) in the base body 80 of the wearable device 100, and may measure a signal indicating the degree of tilting of the wearable device 100 and/or the acceleration of the wearable device 100.

The first angle sensor 524 and the second angle sensor 524-1 may measure hip joint angles according to the leg motion of the user. The first angle sensor 524 may sense the hip joint angle of the right leg of the user, and the second angle sensor 524-1 may sense the hip joint angle of the left leg of the user. Each of the first angle sensor 524 and the second angle sensor 524-1 may include, for example, an encoder and/or a Hall sensor. The hip joint angle of the right leg sensed by the first angle sensor 524 may correspond to a motion value (e.g., a rotation angle value) of a first torque transmission frame (e.g., the first torque transmission frame 55 of FIG. 3) of the wearable device, and the hip joint angle of the left leg sensed by the second angle sensor 524-1 may correspond to a motion value (e.g., a rotation angle value) of a second torque transmission frame (e.g., the second torque transmission frame 50 of FIG. 3) of the wearable device.

In an embodiment, the one or more sensors may further include a torque sensor configured to sense a torque value, a position sensor configured to acquire a position value of the wearable device 100, a proximity sensor configured to detect the proximity of an object, a biosignal sensor configured to detect a biosignal of a user, a distance sensor configured to measure the distance to an object, a pressure sensor configured to measure a pressure value, and/or a temperature sensor configured to measure ambient temperature.

The input circuit 540 may receive a command or data to be used by a component (e.g., the processor 512) of the wearable device 100 from the outside (e.g., the user) of the wearable device 100. The input circuit 540 may include, for example, a key (e.g., a button) and/or a touch screen.

The sound output circuit 550 may output a sound signal to the outside of the wearable device 100. The sound output circuit 550 may include a speaker that plays a guide sound signal (e.g., a driving start sound or an operation error notification sound), music content, or a guiding voice.

In an embodiment, the wearable device 100 may further include a battery (not shown) configured to supply power to each component of the wearable device 100 and a power management circuit (not shown) configured to control the power supply. The wearable device 100 may convert the power of the battery into power suitable for an operating voltage of each component of the wearable device 100 and supply the converted power to each component.

The driving modules 530 and 530-1 may generate external force to be applied to the legs of the user under the control of the control circuit 510. The driving modules 530 and 530-1 may be disposed in positions corresponding to the positions of the hip joints of the user, and may generate torque to be applied to the legs of the user based on a control signal generated by the control circuit 510. The control circuit 510 may transmit the control signal to the motor driver circuits 532 and 532-1, and the motor driver circuits 532 and 532-1 may control the operation of the motors 534 and 534-1 by generating a current signal (or a voltage signal) corresponding to the control signal and supplying the current signal (or the voltage signal) to the motors 534 and 534-1. The current signal may not be supplied to the motors 534 and 534-1 according to the control signal. When the motors 534 and 534-1 are driven as the current signal is supplied to the motors 534 and 534-1, the motors 534 and 534-1 may generate assistance forces for assisting leg motions of the user or resistance forces for hindering leg motions of the user.

The control circuit 510 may control the overall operation of the wearable device 100, and generate a control signal to control each component of the wearable device 100. The control circuit 510 may include the processor 512 and the memory 514.

The processor 512 may execute, for example, software to control at least one other component (e.g., a hardware or software component) of the wearable device directly or indirectly connected to the processor 512, and perform a variety of data processing or computation. According to an embodiment, as at least part of data processing or computation, the processor 512 may store instructions or data received from another component (e.g., the communication circuit 516) in the memory 514, process the instructions or data stored in the memory 514, and store result data obtained as a result of processing in the memory 514. The processor 512 may include one or more processors, and the operations of the wearable device 100 described in the present disclosure may be performed by one processor or by a combination of multiple processors.

According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. The processor 512 may be implemented as a system on chip (SoC) or an IC configured to perform processing. The auxiliary processor may be implemented separately from the main processor or as a part of the main processor.

The memory 514 may store a variety of data used by at least one component (e.g., the processor 512) of the control circuit 510. The variety of data may include, for example, software, sensor data, input data or output data for instructions related thereto. The memory 514 may include at least one instruction executable by the processor 512. The memory 514 may include one or more memories, and the instructions controlled by the processor 512 to perform the operations of the wearable device 100 described herein may be stored in one memory or divided and stored in multiple memories. The memory 514 may include a volatile memory or a non-volatile memory.

The communication circuit 516 may support establishing a direct (e.g., wired) communication channel or a wireless communication channel between the control circuit 510 and another component of the wearable device 100 or an external electronic device (e.g., the electronic device 210 or the other wearable device 220 of FIG. 2) and performing communication via the established communication channel. For example, the communication circuit 516 may transmit the sensor data acquired by the sensor to an external electronic device (e.g., the electronic device 210 of FIG. 2) and receive a control signal from the external electronic device. According to an embodiment, the communication circuit 516 may include one or more CPs that operate independently of the processor 512 and support direct (e.g., wired) communication or wireless communication. According to an embodiment, the communication circuit 516 may include a wireless communication circuit (e.g., a cellular communication circuit, a short-range wireless communication circuit, or a global navigation satellite system (GNSS) communication circuit), and/or a wired communication circuit. The wireless communication circuit may communicate with another component of the wearable device 100 and/or an external device via, for example, Bluetooth™, wireless fidelity (Wi-Fi), advanced and adaptive network technology (ANT) or infrared data association (IrDA), a legacy cellular network, a 5G network, a next-generation network, the Internet, or a computer network (e.g., a local area network (LAN) or a wide area network (WAN)).

The haptic circuit 560 may provide haptic feedback to the user by control of the processor 512. The haptic circuit 560 may include one or a plurality of haptic actuators. A haptic actuator may include, for example, a piezo actuator, a bander type actuator, and/or a vibration motor-based actuator. One or a plurality of haptic actuators may be provided. In an embodiment, the haptic actuator may be disposed in at least one of a base body (e.g., the base body 80 of FIG. 3), a torque transmission frame (e.g., the first torque transmission frame 75 or the second torque transmission frame 70 of FIG. 3), and a thigh fastener (e.g., the first thigh fastener 2 or the second thigh fastener 1 of FIG. 3) of the wearable device 100.

The wearable device 100 may generate torque to assist a posture of the user (e.g., a wearer wearing the wearable device 100). For example, when the wearable device 100 operates in a walking assistance mode, the wearable device 100 may generate appropriate torque to be applied to the user based on a hip joint angle measured through the first angle sensor 524 and/or the second angle sensor 524-1. A walking pattern of the user may be estimated based on the measured hip joint angle, and torque corresponding to each walking pattern may be provided to the user through the wearable device 100. At this time, depending on the purpose of the walking assistance, an assistance force to help with walking may be provided or a resistance force to increase the intensity of walking exercises may be provided through the wearable device 100. When the resistance force to increase the intensity of walking exercises or the resistance force for other exercises is provided, a phenomenon may occur in which the hip joint angle is measured with a slight distortion by the first angle sensor 524 and/or the second angle sensor 524-1. Because, the wearable device 100 (more specifically, a waist support frame (e.g., the waist support frame 20 of FIG. 3)) may be slightly twisted due to the torque in a direction that hinders the leg motion of the user, and due to the twisting of the wearable device 100, the hip joint angle may be measured with a distortion. Alternatively, the hip joint angle may be measured with a distortion even when the wearable device 100 is worn incorrectly on the body of the user (e.g., worn crookedly). The hip joint angle being measured with a distortion may indicate that a hip joint angle measured when the wearable device 100 is twisted is measured differently from a hip joint angle measured when the wearable device 100 is not twisted. As the resistance force provided by the wearable device 100 is strong, a degree of twisting of the wearable device 100 may increase, and accordingly, the distortion of the hip joint angle may further increase. The hip joint angle measured differently from the actual angle due to the distortion may reduce the accuracy of determining a walking pattern (or a gait phase) of the user and determining torque parameters (e.g., a torque intensity and a torque occurrence time point).

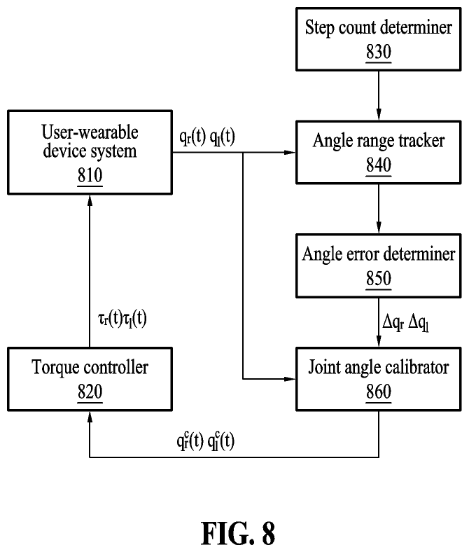

In an embodiment, the wearable device 100 may calibrate (or compensate) the distortion of the hip joint angle as described above. The wearable device 100 may estimate a degree of twisting of the wearable device 100 from the measured hip joint angle and calibrate the hip joint angle in real time based on the estimated degree of twisting. The wearable device 100 may determine the number of steps of the user based on sensor data and track a range of motion (ROM) (e.g., the angle range of the hip joint angle) of a leg of the user based on the determined number of steps. The wearable device 100 may calculate a twist angle from the ROM of the leg of the user and determine a joint angle calibration value from the twist angle. The wearable device 100 may perform angle calibration by applying the joint angle calibration value to the measured hip joint angle, and may perform torque control based on the calibrated hip joint angle. Through the angle calibration, it is possible to obtain a more accurate hip joint angle for the motion of the leg of the user. The torque control may be performed more accurately by a more accurate hip joint angle, and user inconvenience caused by inaccurate torque may be reduced. The angle calibration performed by the wearable device 100 is described in more detail below with reference to FIGS. 8 to 18.

The wearable device 100 having a joint angle calibration function according to an embodiment may include a driving module 530; 530-1 including a motor 534; 534-1, a torque transmission frame (e.g., the first torque transmission frame 55 and the second torque transmission frame 50 of FIG. 3) configured to transmit torque generated by the motor 534; 534-1 to a leg of a user, a sensor including an angle sensor (e.g., the first angle sensor 524 or the second angle sensor 524-1) configured to measure a joint angle (e.g., a hip joint angle) of the user corresponding to an angle of the torque transmission frame, and one or more processors 512 configured to calibrate the joint angle and control the motor 534; 534-1 based on the calibrated joint angle. The one or more processors 512 may determine the number of steps of the user wearing the wearable device 100 using sensor data obtained from a sensor. For example, a walking pattern may be estimated from sensor data of a hip joint angle measured from the first angle sensor 524 and/or the second angle sensor 524-1, and the number of steps may be counted whenever a specific walking time point (e.g., a heel strike or toe-off) is detected in the estimated walking pattern. In another example, a walking pattern may be estimated from sensor data of an acceleration and/or angular velocity measured from the IMU 522, and the number of steps may be counted whenever the specific walking time point is detected in the estimated walking pattern. The method of counting the number of steps is not limited thereto.

In an embodiment, the one or more processors 512 may track an angle range of a joint angle of the user based on the determined number of steps and the joint angle of the user measured by the wearable device 100. The one or more processors 512 may determine an angle range of a change in a first joint angle corresponding to a motion of a right leg of the user and an angle range of a change in a second joint angle corresponding to a motion of a left leg of the user from a previously measured joint angle each time the number of steps changes. The one or more processors 512 may extract extreme values of a joint angle from previously measured joint angle data each time the number of steps changes, and determine the angle range of the joint angle based on the extracted extreme values. The extreme values may include a maximum value and a minimum value. In an embodiment, the previously measured joint angle data may be data for the joint angle measured during an interval in which the number of steps immediately before a change in the number of steps is maintained.

In an embodiment, the one or more processors 512 may determine the joint angle calibration value based on the tracked angle range. The one or more processors 512 may determine an angle error based on the determined angle range of the joint angle, and determine the joint angle calibration value based on the angle error.

In an embodiment, the one or more processors 512 may determine a first average value based on a maximum value and a minimum value extracted from an angle range of a joint angle of a first joint (e.g., a right hip joint) of the user. For example, an average value of the maximum value and the minimum value extracted from the angle range of one cycle for the joint angle of the first joint may be determined as the first average value. The one or more processors 512 may determine a second average value based on a maximum value and a minimum value extracted from an angle range of a joint angle of a second joint (e.g., a left hip joint) of the user. For example, an average value of the maximum value and the minimum value extracted from the angle range of one cycle for the joint angle of the second joint may be determined as the second average value. The one or more processors 512 may determine the angle error based on the first average value and the second average value.

In an embodiment, the one or more processors 512 may determine an angle error for the joint angle of the first joint based on a result value obtained by subtracting the first average value from the second average value. For example, the result value obtained by subtracting the first average value from the second average value may be determined as the angle error for the joint angle of the first joint.

In an embodiment, the one or more processors 512 may determine an angle error for the joint angle of the second joint based on a result value obtained by subtracting the second average value from the first average value. For example, the result value obtained by subtracting the second average value from the first average value may be determined as the angle error for the joint angle of the second joint.

In an embodiment, the one or more processors 512 may determine a calibrated joint angle based on the measured joint angle and the determined joint angle calibration value. The one or more processors 512 may determine a first joint angle calibration value dependent on the determined angle error for the joint angle of the first joint and a second joint angle calibration value dependent on the determined angle error for the joint angle of the second joint. The one or more processors 512 may determine a calibrated joint angle for the first joint by adjusting the measured joint angle of the first joint based on the first joint angle calibration value. The one or more processors 512 may determine a calibrated joint angle for the second joint by adjusting the measured joint angle of the second joint based on the second joint angle calibration value.

In an embodiment, the one or more processors 512 may control a torque output of the motor 534; 534-1 based on the calibrated joint angle. Based on the calibrated joint angle, the intensity of torque and/or a time point of torque application may be determined.

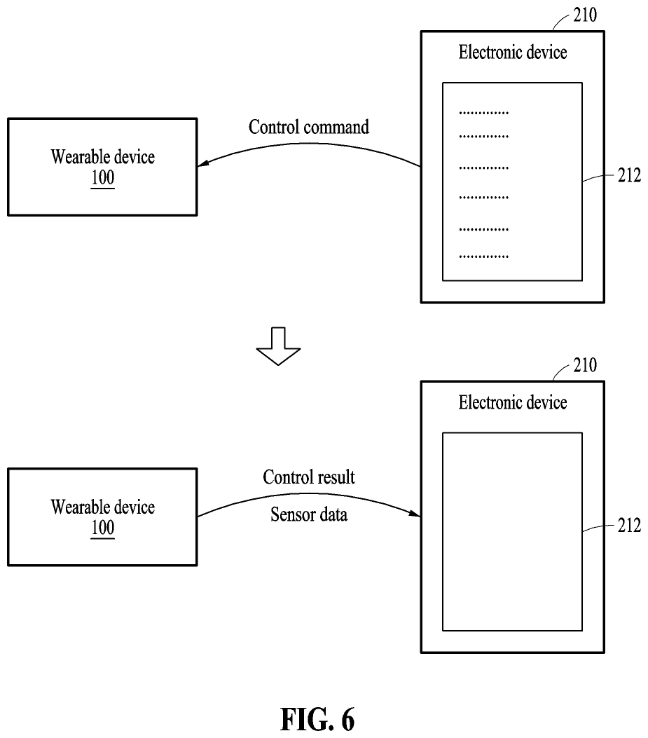

FIG. 6 is a diagram illustrating an interaction between a wearable device and an electronic device according to various embodiments.

Referring to FIG. 6, the wearable device 100 may communicate with the electronic device 210. For example, the electronic device 210 may be a user terminal of a user who uses the wearable device 100. In an embodiment, the wearable device 100 and the electronic device 210 may be connected to each other via short-range wireless communication (e.g., Bluetooth™ or Wi-Fi communication).

In an embodiment, the electronic device 210 may check a state of the wearable device 100 or execute an application to control or operate the wearable device 100. A screen of a UI may be displayed to control an operation of the wearable device 100 or determine an operating mode of the wearable device 100 on a display 212 of the electronic device 210 through the execution of the application. The UI may be, for example, a GUI.

In an embodiment, the user may input an instruction for controlling the operation of the wearable device 100 (e.g., an execution instruction to a walking assistance mode or an exercise assistance mode) or change settings of the wearable device 100 through a GUI screen on the display 212 of the electronic device 210. The electronic device 210 may generate a control command (or control signal) corresponding to an operation control command or a setting change command input by the user and transmit the generated control command to the wearable device 100. The wearable device 100 may operate according to the received control command and may transmit a control result according to the received control command and/or sensor data sensed by a sensor module of the wearable device 100 to the electronic device 210. The electronic device 210 may provide the user with result information (e.g., current exercise state information, exercise result information, exercise posture assessment information, and physical ability assessment information) derived by analyzing the control result and/or the sensor data through the GUI screen.

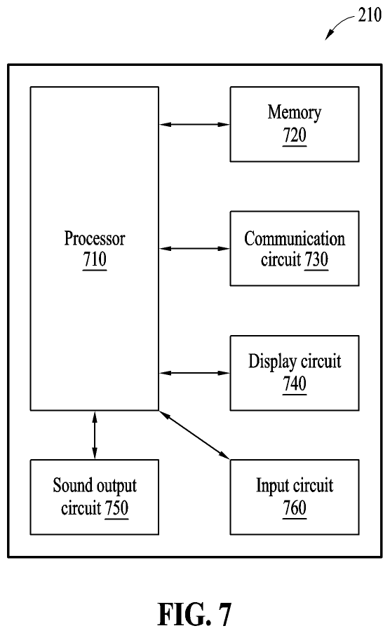

FIG. 7 is a diagram illustrating components of an electronic device according to various embodiments.

Referring to FIG. 7, the electronic device 210 may include a processor 710, a memory 720, a communication circuit 730, a display circuit 740, a sound output circuit 750, and an input circuit 760. In an embodiment, at least one (e.g., the sound output circuit 750) of these components may be omitted from the electronic device 210, or one or more other components (e.g., a sensor circuit, a haptic circuit, and a battery) may be added thereto.

The processor 710 may control at least one other component (e.g., a hardware or software component) of the electronic device 210 and may perform a variety of data processing or computation. According to an embodiment, as at least part of data processing or computation, the processor 710 may store instructions or data received from another component (e.g., the communication circuit 730) in the memory 720, process the instructions or data stored in the memory 720, and store result data in the memory 720. The processor 710 may include one or more processors, and the operations of the electronic device 210 described in the present disclosure may be performed by one processor or by a combination of multiple processors.

According to an embodiment, the processor 710 may include at least one of a main processor (e.g., a central processing unit (CPU) or an application processor (AP)) or an auxiliary processor (e.g., a graphics processing unit (GPU)), a neural processing unit (NPU), an image signal processor (ISP), a sensor hub processor, or a communication processor (CP)) that is operable independently of, or in conjunction with the main processor. The processor 512 may be implemented as an SoC or an IC configured to perform processing.

The memory 720 may store a variety of data used by at least one component (e.g., the processor 710 or the communication circuit 730) of the electronic device 210. The data may include, for example, a program (e.g., an application) and input data or output data for an instruction related thereto. The memory 720 may include at least one instruction executable by the processor 710. The memory 720 may include one or more memories, and the instructions controlled by the processor 710 to perform the operations of the electronic device 210 described herein may be stored in one memory or divided and stored in multiple memories. The memory 720 may include a volatile memory or a non-volatile memory.

The communication circuit 730 may support establishing a direct (e.g., wired) communication channel or a wireless communication channel between the electronic device 210 and another electronic device (e.g., the wearable device 100, the other wearable device 220, or the server 230) and performing communication via the established communication channel. The communication circuit 730 may include a communication circuit configured to perform a communication function. The communication circuit 730 may include one or more CPs that operate independently of the processor 710 (e.g., an AP) and support direct (e.g., wired) communication or wireless communication. According to an embodiment, the communication circuit 730 may include a wireless communication circuit configured to perform wireless communication (e.g., a Bluetooth communication circuit, a cellular communication circuit, a Wi-Fi communication circuit, or a GNSS communication circuit) or a wired communication circuit (e.g., a LAN communication circuit or a power line communication (PLC) circuit). For example, the communication circuit 730 may transmit a control instruction to the wearable device 100 and receive, from the wearable device 100, at least one of sensor data including body motion information of a user who is wearing the wearable device 100, state data of the wearable device 100, or control result data corresponding to the control instruction.

The display circuit 740 may visually provide information to the outside (e.g., the user) of the electronic device 210. The display circuit 740 may include, for example, a liquid-crystal display (LCD) or organic light-emitting diode (OLED) display, a hologram device, or a projector device. The display circuit 740 may further include a control circuit configured to control the driving of a display. In an embodiment, the display circuit 740 may further include a touch sensor configured to sense a touch or a pressure sensor configured to measure the magnitude of force generated by the touch. The display circuit 740 may output a UI screen for controlling the wearable device 100 or providing a variety of information (e.g., exercise evaluation information and setting information of the wearable device 100).

The sound output circuit 750 may output a sound signal to the outside of the electronic device 210. The sound output circuit 750 may include a guide sound signal (e.g., a driving start sound or an operation error notification sound) based on a state of the wearable device 100 and a speaker for playing musical content or a guiding voice.

The input circuit 760 may receive a command or data to be used by a component (e.g., the processor 710) of the electronic device 210 from the outside (e.g., the user) of the electronic device 210. The input circuit 760 may include an input component circuit and may receive a user input. The input circuit 760 may include, for example, a touch recognition circuit for recognizing a touch on a key (e.g., a button) and/or a screen.

FIG. 8 is a diagram illustrating a control system for performing calibration of a joint angle and controlling torque of a wearable device based on the calibrated joint angle according to various embodiments.

Referring to FIG. 8, a control system may include a user-wearable device system 810, a torque controller 820, a step count determiner 830, an angle range tracker 840, an angle error determiner 850, and a joint angle calibrator 860. In an embodiment, the operations of the torque controller 820, the step count determiner 830, the angle range tracker 840, the angle error determiner 850, and the joint angle calibrator 860 may be performed by a processor (e.g., the processor 512 of FIG. 5) included in the wearable device 100.

The user-wearable device system 810 is a system in which a user wearing the wearable device 100 interacts with the wearable device 100, and the wearable device 100 may measure joint angles (e.g., hip joint angles) qᵣ(t) and qₗ(t) of the user using an angle sensor (e.g., the first angle sensor 524 or the second angle sensor 524-1 of FIG. 5), and generate torque to be applied to the user based on torque control signals τᵣ(t) and τₗ(t) determined by the torque controller 820. In an embodiment, qᵣ(t) may represent a joint angle of a right hip joint of the user over time, and qₗ(t) may represent a joint angle of a left hip joint of the user over time. τᵣ(t) may represent a torque control signal for controlling the torque to be applied to the right leg of the user over time, and may represent a torque control signal for controlling the torque to be applied to the left leg of the user over time.

The joint angle calibrator 860 may calibrate a distortion included in each of joint angles qᵣ(t) and qₗ(t) measured in real time to determine calibrated joint angles

$${q}_{r}^{c} ( t ) and {q}_{r}^{c} ( t ) .$$

The torque controller 820 may determine the torque control signals τᵣ(t) and τₗ(t) based on the calibrated joint angles

$${q}_{r}^{( c )} ( t ) and {q}_{l}^{c} ( t ) .$$

In an embodiment, the torque controller 820 may receive not only the calibrated joint angles

$${q}_{r}^{( c )} ( t ) and {q}_{l}^{c} ( t )$$

but also other additional information. The process of the joint angle calibrator 860 calibrating the joint angles qᵣ(t) and qₗ(t) and determining the calibrated joint angles

$${q}_{r}^{c} ( t ) and {q}_{r}^{c} ( t )$$

is as follows.

The step count determiner 830 may determine the number of steps of a user wearing the wearable device 100 using sensor data obtained from a sensor (e.g., the IMU 522, the first angle sensor 524, or the second angle sensor 524-1 of FIG. 5) of the wearable device 100. For example, the step count determiner 830 may measure a change in acceleration values according to the motion of the user through the IMU, and the number of steps may be counted whenever a specific pattern (e.g., a bouncing value) appearing when the user's foot touches the ground in the measured acceleration values is detected. However, there may be various methods of counting the number of steps, and the method is not limited thereto. The number of steps may be counted in real time while the user walks wearing the wearable device 100.

The number of steps determined by the step count determiner 830 and the joint angles qᵣ(t) and qₗ(t) measured by the wearable device 100 may be transmitted to the angle range tracker 840. The angle range tracker 840 may track the angle range of the joint angle of the user based on the determined number of steps and joint angles qᵣ(t) and qₗ(t) In an embodiment, the angle range tracker 840 may determine an angle range of a change in the joint angle qᵣ(t) corresponding to a motion of a right leg of the user and an angle range of a change in a joint angle qₗ(t) corresponding to a motion of a left leg of the user from a previously measured joint angle (e.g., a recently measured joint angle) each time the number of steps changes. The angle range tracker 840 may track new extreme values (a maximum value and a minimum value) of the joint angle from the previously measured joint angle each time the number of steps changes (or each time the number of steps is counted).

The angle error determiner 850 may determine angle errors Δqᵣ and ₗpΔ based on the angle range tracked by the angle range tracker 840. The angle range tracked by the angle range tracker 840 may change each time the number of steps changes, and the angle error determiner 850 may calculate the angle error Δqᵣ for the joint angle of a first joint (e.g., a right hip joint) and the angle error Δqₗ for the joint angle of a second joint (e.g., a left joint) based on the angle range of the joint angle that is updated each time the number of steps changes.

The joint angles qᵣ(t) and qₗ(t) measured by the wearable device 100 and the angle errors Δqᵣ and Δqₗ determined by the angle error determiner 850 may be transmitted to the joint angle calibrator 860. The joint angle calibrator 860 may determine a joint angle calibration value based on the angle errors Δqᵣ and Δqₗ, and apply the determined joint angle calibration value to the measured joint angles qᵣ(t) and qₗ(t) to determine the calibrated joint angles

$${q}_{r}^{c} ( t ) and {q}_{r}^{c} ( t ) .$$

The joint angle calibrator 860 may, for example, determine joint angle calibration values δqᵣ and δqₗ that make the angle errors and zero, and calculate the calibrated joint angles

$${q}_{r}^{( c )} ( t ) and {q}_{l}^{c} ( t )$$

by adding the determined joint angle calibration values δqᵣ and δqᵣ to the joint angles qᵣ(t) and qₗ(t). In an embodiment, other additional information (e.g., a walking speed of the user) may be input to the joint angle calibrator 860. The joint angle calibrator 860 may adjust a calibration time point or whether to calibrate the joint angle based on the other additional information. The joint angle calibrator 860 may transmit the joint angles qᵣ(t) and qₗ(t) to the torque controller 820 without calibrating the joint angles qᵣ(t) and qₗ(t) when the walking speed of the user is less than a threshold value, for example. In this case, the torque controller 820 may generate a torque control signal based on the uncalibrated joint angles qᵣ(t) and qₗ(t).

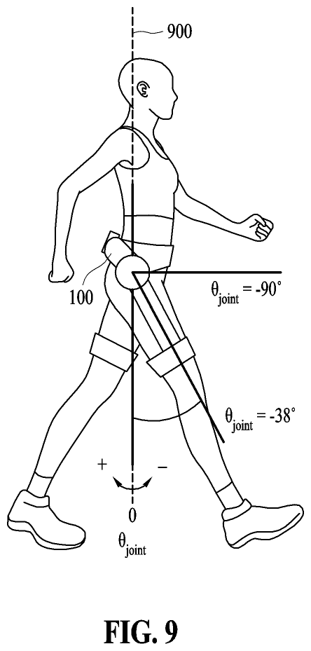

FIG. 9 is a diagram illustrating a joint angle measured by a wearable device according to various embodiments.

Referring to FIG. 9, a joint angle (e.g., a hip joint angle) θⱼₒᵢₙₜ of a user may be measured by an angle sensor (e.g., the first angle sensor 524 or the second angle sensor 524-1 of FIG. 5) of the wearable device 100. In an embodiment, the joint angle θⱼₒᵢₙₜ may be defined as a value of 0 degrees when a torque transmission frame (e.g., the first torque transmission frame 55 or the second torque transmission frame 50 of FIG. 3) of the wearable device 100 coincides with a gravity line 900 perpendicular to the horizon. A motion of the torque transmission frame may correspond to a motion of a leg of the user. The joint angle θⱼₒᵢₙₜ may be defined as a negative value when the torque transmission frame is in a forward direction of the user, and may be defined as a positive value when the torque transmission frame is in a rear direction of the user. For example, as shown in FIG. 9, the joint angle θⱼₒᵢₙₜ when the user extends the right leg forward may be measured as −38 degrees. However, the method of defining the joint angle θⱼₒᵢₙₜ is not limited thereto.

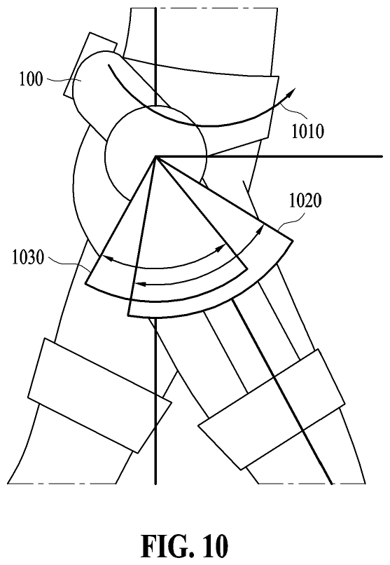

FIGS. 10 and 11 are diagrams illustrating occurrence of a distortion in a joint angle measured by a wearable device.

Referring to FIG. 10, when a user wears the wearable device 100 and performs an exercise such as walking, a wearing state of the wearable device 100 may be changed by the engagement of a force. For example, when a resistance force is provided from the wearable device 100 to hinder the motion of a right leg of the user and the user moves the right leg in a direction opposite to a direction, in which the resistance force of the wearable device 100 acts, the wearable device 100 (or the waist support frame 20 of the wearable device 100) may rotate or twist in a direction 1010. The greater the resistance force provided by the wearable device 100, the greater the rotation or twisting of the wearable device 100. Even if the wearable device 100 is initially fastened tightly to the waist of the user so that the wearable device 100 does not slip off the waist of the user, it is difficult to avoid the rotation or twisting of the wearable device 100 as described above because the user's body is not a rigid body.

If no rotation or twisting of the wearable device 100 occurs, the range of joint angles measured by the angle sensor of the wearable device 100 may have a range 1020, however, due to the rotation or twisting of the wearable device 100, the range of joint angles measured may be measured as a range 1030. In this way, when the rotation or twisting of the wearable device 100 occurs, the joint angle may be measured in a distorted manner.

FIG. 11 illustrates graphs 1112, 1114, 1122, and 1124 showing joint angles measured over time while a user wearing the wearable device 100 is walking. The graphs 1112 and 1114 respectively show a joint angle of a first joint (e.g., a right hip joint) and a joint angle of a second joint (e.g., a left hip joint) measured in a case 1110 in which no rotation or twisting of the wearable device 100 occurs. The graphs 1122 and 1124 respectively show a joint angle of a first joint (e.g., a right hip joint) and a joint angle of a second joint (e.g., a left hip joint) measured in a case 1120 in which the rotation or twisting of the wearable device 100 occurs. The joint angle of the first joint shown in the graph 1112 and the graph 1122 may be measured by a first angle sensor (e.g., the first angle sensor 524 of FIG. 5) of the wearable device 100. The joint angle of the second joint shown in the graph 1114 and the graph 1124 may be measured by a second angle sensor (e.g., the second angle sensor 524-1 of FIG. 5) of the wearable device 100.

If no rotation or twisting of the wearable device 100 occurs, the joint angle of the first joint and the joint angle of the second joint may have the same or similar extreme values as in the graphs 1112 and 1114. When comparing the graphs 1112, 1114, 1122, and 1124, it may be seen that, when the rotation or twisting of the wearable device 100 occurs, the joint angle of one side is measured as a more positive value and the joint angle of the other side is measured as a more negative value. The graphs 1122 and 1124 show cases in which the joint angle of the first joint is measured with a greater positive bias and the joint angle of the second joint is measured with a greater negative bias.

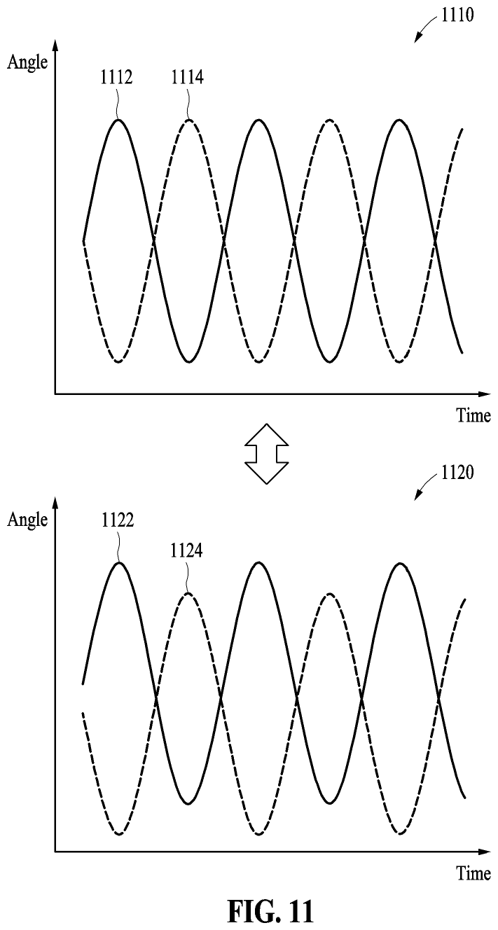

FIG. 12 is a diagram illustrating an operation of determining the number of steps according to various embodiments.

Referring to FIG. 12, graphs 1220 and 1230 respectively show a joint angle of a first joint (e.g., a right hip joint) and a joint angle of a second joint (e.g., a left hip joint) measured over time when a user walks while wearing the wearable device 100. The joint angle of the first joint and the joint angle of the second joint may be measured by an angle sensor (e.g., the first angle sensor 524 or the second angle sensor 524-1 of FIG. 5) of the wearable device 100.

A processor (e.g., the processor 512 of FIG. 5) of the wearable device 100 may determine the number of steps of a user wearing the wearable device 100 using sensor data obtained from a sensor (e.g., the IMU 522, the first angle sensor 524, or the second angle sensor 524-1 of FIG. 5)) of the wearable device 100. There may be various methods of determining the number of steps based on the sensor data and the method is not limited to a specific method. A graph 1210 shows a change in the number of steps determined over time when the user walks while wearing the wearable device 100. The number of steps may be increased by counting each step the user takes. In an embodiment, when the number of steps is counted when the user's foot touches the ground, a relationship may appear in which the number of steps increases at the moment when at least one of the joint angle of the first joint and the joint angle of the second joint becomes 0 degrees or approaches 0 degrees. The number of steps may be counted in real time while the user is walking.

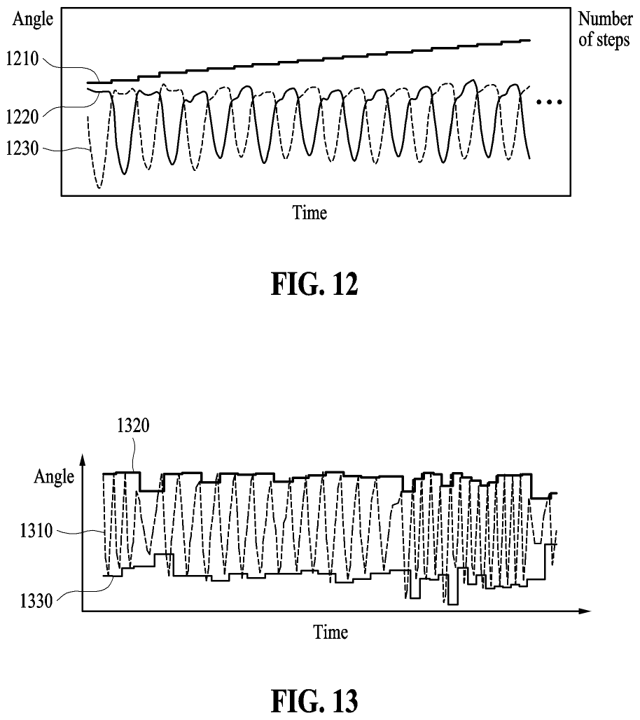

FIG. 13 is a diagram illustrating an operation of tracking an angle range for a joint angle according to various embodiments.

Referring to FIG. 13, a graph 1310 shows a joint angle of a first joint (e.g., a right hip joint) measured over time when the user walks while wearing the wearable device 100. A processor (e.g., the processor 512 of FIG. 5) of the wearable device 100 may track an angle range for the joint angle of the first joint. The processor may determine the angle range for a change in the joint angle from previously measured joint angles each time the number of steps of the user changes (e.g., each time the number of steps increases).

The processor may track which angle range the joint angle moves in over time. In an embodiment, the processor may extract a minimum value and a maximum value of the joint angle from previously measured joint angle data each time the number of steps changes, and determine an angle range of the joint angle based on the extracted minimum value and maximum value. The processor may extract a minimum value and a maximum value from previously tracked and stored joint angle values each time the number of steps is counted. For example, assuming that a stride time, which refers to a time interval between two points where the same foot touches the ground in succession during the walking of a user, is 2 seconds or less, and that up to 200 joint angle values of the first joint, which are measured every 10 milliseconds (ms), are measured during one stride time, the minimum value and the maximum value of the joint angle value from the most recent (or previous stride time) may be extracted each time the number of steps is counted. This process may be performed during every stride time and the angle range of the joint angle may be continuously updated. A graph 1320 for the maximum value and a graph 1330 for the minimum value extracted each time the number of steps changes from the joint angles of the first joint shown in the graph 1310 are shown. The graph 1320 and the graph 1330 each show a graph connecting the maximum values and the minimum values of the joint angle of the first joint for each step of the user.

The processor may also track an angle range of a joint angle of a second joint (e.g., a left hip joint) according to the same method as described above. The processor may determine an angle range of a change in a first joint angle corresponding to a motion of a right leg of the user and an angle range of a change in a second joint angle corresponding to a motion of a left leg of the user from a previously measured joint angle each time the number of steps changes (e.g., each time the number of steps increases).

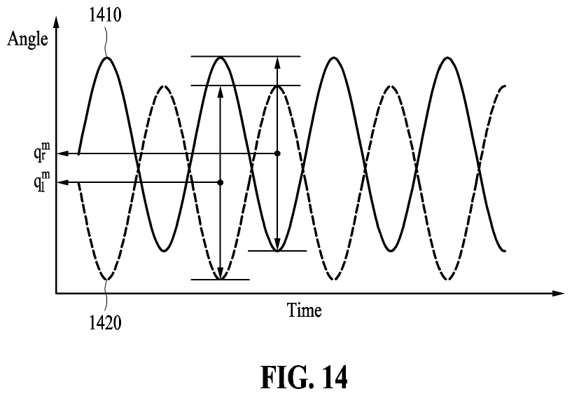

FIG. 14 is a diagram illustrating an operation of determining a joint angle calibration value according to various embodiments.

A processor (e.g., the processor 512 of FIG. 5) of the wearable device 100 may determine an angle error of each joint angle based on the angle range tracked by the process described above with reference to FIG. 13, and determine the joint angle calibration value based on the determined angle error.

Referring to FIG. 14, graphs 1410 and 1420 respectively show a joint angle of a first joint (e.g., a right hip joint) and a joint angle of a second joint (e.g., a left hip joint) measured over time when the user walks while wearing the wearable device 100. According to the graphs 1410 and 1420, the joint angle of the first joint and the joint angle of the second joint appear to be measured with a bias in a positive or negative direction. Accordingly, it may be expected that the joint angle is measured while the wearable device 100 is rotated or twisted.

The processor may determine the angle error for each stride time based on the previously determined angle range of the joint angle. The angle error may represent a distorted angle or a twist angle. The angle error may correspond to a difference between

$${q}_{r}^{m} and {q}_{l}^{m}$$

shown in the drawing.

$${q}_{r}^{m}$$

may represent an average value of the maximum and minimum values extracted from the angle range of the joint angle of the first joint.

$${q}_{l}^{m}$$

may represent an average value of the maximum and minimum values extracted from the angle range of the joint angle of the second joint.

$${q}_{r}^{m} ( N ) and {q}_{l}^{m} ( N ) ,$$

representing

$${q}_{r}^{m} and {q}_{l}^{m}$$

within an N-th (N is a natural number greater than or equal to 1) stride time, may be calculated by Equations 1 and 2 below.

$${q}_{r}^{m} ( N )$$

represents an average value of the maximum and minimum values of the angle range of the joint angle of the first joint within the N-th stride time, and

$${q}_{l}^{m} ( N )$$

represents an average value of maximum and minimum values of the angle range of the joint angle of the second joint within the N-th stride time.

$${q}_{r}^{m} ( N ) = \frac{1}{2} \cdot ( {max}_{{t}_{n} ∈ {T}_{N}} {q}_{r} ( {t}_{n} ) + {min}_{{t}_{n} ∈ {T}_{N}} {q}_{r} ( {t}_{n} ) ) \qquad [ Equation 1 ]$$

$${q}_{l}^{m} ( N ) = \frac{1}{2} \cdot ( {max}_{{t}_{n} ∈ {T}_{N}} {q}_{l} ( {t}_{n} ) + {min}_{{t}_{n} ∈ {T}_{N}} {q}_{l} ( {t}_{n} ) ) \qquad [ Equation 2 ]$$

Here,

$${max}_{{t}_{n} ∈ {T}_{N}} {q}_{r} ( {t}_{n} )$$

represents a maximum value extracted from the angle range of the joint angle of the first joint measured within the N-th stride time, and

$${min}_{{t}_{n} ∈ {T}_{N}} {q}_{r} ( {t}_{n} )$$

represents minimum value extracted from the angle range of the joint angle of the first joint measured within the N-th stride time.

$${max}_{{t}_{n} ∈ {T}_{N}} {q}_{l} ( {t}_{n} )$$

represents a maximum value extracted from the angle range of the joint angle of the second joint measured within the N-th stride time, and

$${min}_{{t}_{n} ∈ {T}_{N}} {q}_{l} ( {t}_{n} )$$

represents a minimum value extracted from the angle range of the joint angle of the second joint measured within the N-th stride time. T_{N} represents a set of time points tₙ belonging to an interval of the N-th stride time. qᵣ(t) represents a joint angle value of the first joint at the time point tₙ, and qₗ(tₙ) represents a joint angle value of the second joint at the time point tₙ.

In an embodiment, an angle error Δqᵣ for the joint angle of the first joint and an angle error Δqₗ for the joint angle of the second joint may be calculated by Equations 3 and 4 below.

$$Δ {q}_{r} = {q}_{l}^{m} ( N ) - {q}_{r}^{m} ( N ) \qquad [ Equation 3 ]$$

$$Δ {q}_{l} = {q}_{r}^{m} ( N ) - {q}_{l}^{m} ( N ) \qquad [ Equation 4 ]$$

In an embodiment, the angle error Δqᵣ may be determined as a value obtained by subtracting

$${q}_{r}^{m} ( N )$$

from

$${q}_{l}^{m} ( N )$$

as in Equation 3, and the angle error Δqₗ may be determined as a value obtained by subtracting

$${q}_{l}^{m} ( N )$$

from

$${q}_{r}^{m} ( N )$$

as in Equation 4. If there is no rotation or twisting of the wearable device 100,

$${q}_{l}^{m} ( N ) and {q}_{r}^{m} ( N )$$

have similar values to each other, and thus, the values of Δqᵣ and Δqₗ may be close to 0. As the rotation or twisting of the wearable device 100 is great, a difference between

$${q}_{l}^{m} ( N ) and {q}_{r}^{m} ( N )$$

increases, and the values of Δqᵣ and Δqₗ may increase.

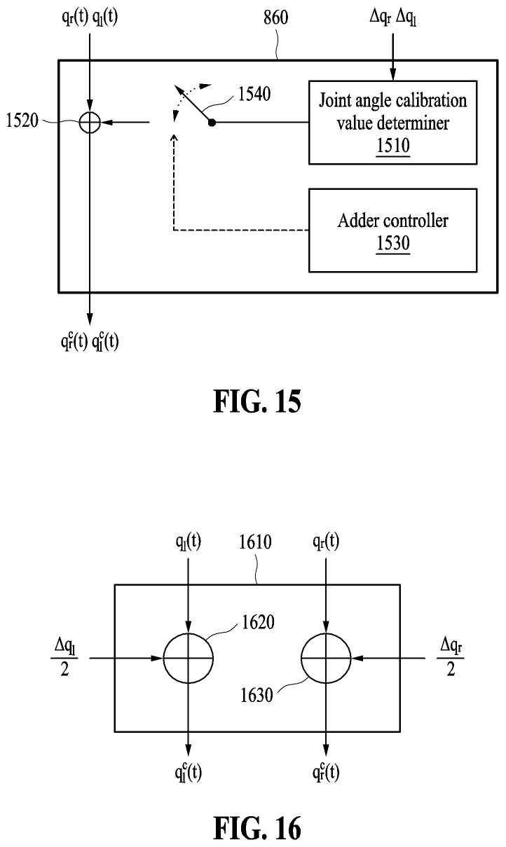

In an embodiment, the processor may determine a joint angle calibration value that makes the angle error Δqᵣ zero for the joint angle of the first joint, and determine a joint angle calibration value that makes the angle error Δqₗ zero for the joint angle of the second joint. FIG. 15 is a diagram illustrating components of a joint angle calibrator according to various embodiments.

Referring to FIG. 15, the joint angle calibrator 860 may determine calibrated joint angles

$${q}_{l}^{c} ( N ) and {q}_{r}^{c} ( N )$$

based on the joint angle calibration value and the joint angles qᵣ(t) and qₗ(t) measured by the wearable device 100.

$${q}_{r}^{c} ( N )$$

may correspond to the calibrated joint angle of the right leg (or the first joint), and

$${q}_{l}^{c} ( N )$$

may correspond to the calibrated joint angle of the left leg (or the second joint). The joint angle calibrator 860 may include a joint angle calibration value determiner 1510, an adder 1520, and an adder controller 1530. In an embodiment, the operations of the joint angle calibration value determiner 1510, the adder 1520, and the adder controller 1530 may be performed by a processor (e.g., the processor 512 of FIG. 5) included in the wearable device 100.

The joint angle calibration value determiner 1510 may determine a first joint angle calibration value dependent on the angle error for the joint angle of the first joint and a second joint angle calibration value dependent on the angle error for the joint angle of the second joint. In an embodiment, the joint angle calibration value determiner 1510 may determine joint angle calibration values δqᵣ and δqᵣ to be applied each of joint angles qᵣ(t) and qₗ(t) based on the angle errors Δqᵣ and Δqₗ determined by Equations 3 and 4 above. The joint angle calibration value determiner 1510 may determine the joint angle calibration values δqᵣ and δqᵣ such that the angle error Δqᵣ and Δqₗ become, for example, zero. In an embodiment, the joint angle calibration value determiner 1510 may include a proportional integral derivative (PID) controller (not shown) for determining the joint angle calibration value. The PID controller may consider input angle errors Δqᵣ and Δqₗ as error values, and output the joint angle calibration values δqᵣ and δqₗ to make the angle Δqᵣ errors and Δqₗ zero. For example, the PID controller may, for example, output a result value of linearly combining a value of an angle error itself, a derivative of the angle error, and a value proportional to an integral of the angle error as the joint angle calibration value.

The joint angle calibrator 860 may determine the calibrated joint angle

$${q}_{r}^{c} ( t )$$

by adjusting the joint angle qᵣ(t) based on the determined joint angle calibration value δqᵣ. The joint angle calibrator 860 may determine the calibrated joint angle

$${q}_{l}^{c} ( t )$$

by adjusting the joint angle qₗ(t) based on the determined joint angle calibration value δqₗ.

For example, the adder 1520 of the joint angle calibrator 860 may determine a corresponding calibrated joint angle by adding the determined joint angle calibration value to the measured joint angle. The adder 1520 may add an angle calibration value δqᵣ to the joint angle qᵣ(t), thereby obtaining the calibrated joint angle

$${q}_{r}^{c} ( t )$$

The adder 1520 may add an angle calibration value δqₗ to the joint angle qₗ(t), thereby obtaining the calibrated joint angle

$${q}_{l}^{c} ( t ) .$$

The adder 1520 may not perform the calibration for the joint angle under the control of the adder controller 1530. When the joint angle calibration is not performed, the adder 1520 may output the input value as is.

The adder controller 1530 may control whether to perform the angle calibration by the adder 1520. For example, when a non-calibration condition, which is a condition in which no calibration is performed, is satisfied, the adder controller 1530 may not connect the joint angle calibration value determiner 1510 and the adder 1520 through a switch 1540. When the joint angle calibration value determiner 1510 and the adder 1520 are not connected to each other, the adder 1520 may output the input joint angles qᵣ(t) and qₗ(t) as they are without the angle calibration process. The adder controller 1530 may receive other information such as a walking speed, and may determine whether the non-calibration condition is satisfied based on the other information received. The case where the non-calibration condition is satisfied may include, for example, a case where the walking speed of the user is less than a threshold value, a case where it is determined that the user has stopped walking, or a case where it is determined that an unusual situation (e.g., the user falling or walking on a ramp/stairs) has occurred, but embodiments are not limited thereto. When the non-calibration condition is not satisfied, the adder controller 1530 may connect the joint angle calibration value determiner 1510 and the adder 1520 through the switch 1540. In this case, the angle calibration values δqᵣ and δqₗ may be transmitted from the joint angle calibration value determiner 1510 to the adder 1520, and the adder 1520 may calculate the calibrated joint angles

$${q}_{r}^{c} ( t ) and {q}_{l}^{c} ( t )$$

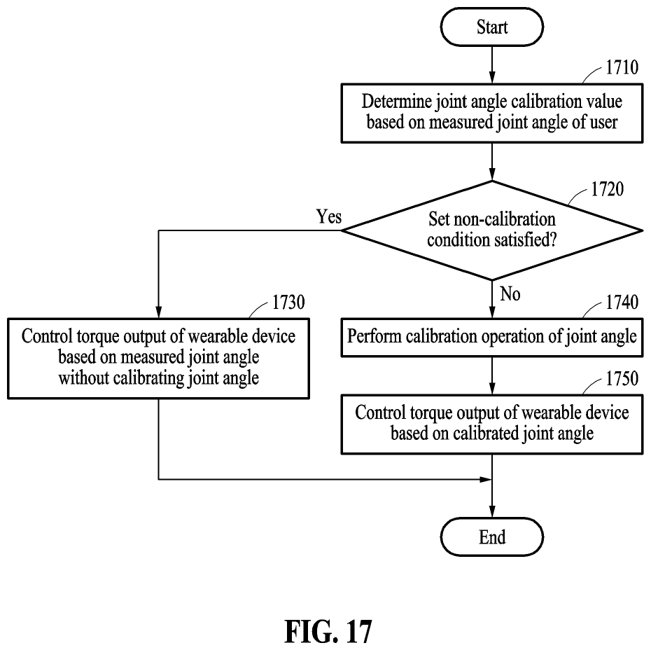

based on the angle calibration values δqᵣ and δqₗ. FIG. 16 is a diagram illustrating components of a joint angle calibrator according to various embodiments.

Referring to FIG. 16, a joint angle calibrator 1610 (e.g., the joint angle calibrator 860 of FIG. 8) may be implemented with a plurality of adders 1620 and 1630. The adder 1620 may output a calibrated joint angle

$${q}_{l}^{c} ( t )$$

by adding a half of an angle error Δqₗ (corresponding to a joint angle calibration value δqₗ) to a joint angle qₗ(t) measured by the wearable device 100. The adder 1620 may output a calibrated joint angle

$${q}_{r}^{c} ( t )$$

by adding a half of an angle error Δqᵣ (corresponding to a joint angle calibration value δqᵣ) to a joint angle qᵣ(t) measured by the wearable device 100. The joint angle calibrator 1610 has a simple configuration and does not require other information to determine whether the non-calibration condition is satisfied.

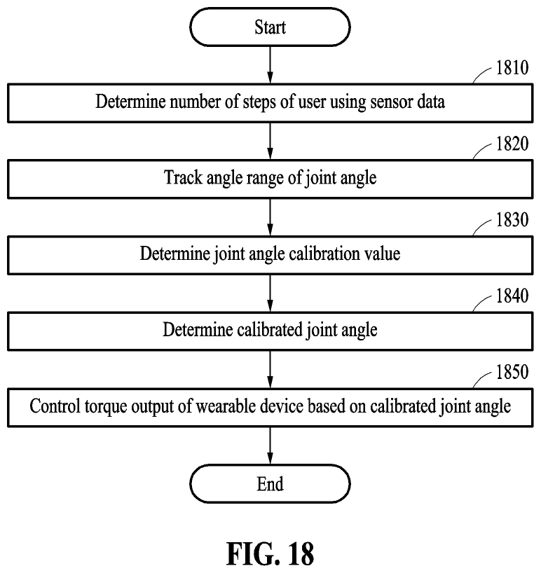

FIGS. 17 and 18 are flowcharts illustrating operations of an operating method of a wearable device according to an embodiment. In an embodiment, at least one of operations of FIGS. 17 and 18 may be performed simultaneously or in parallel with another operation, and the order of the operations may be changed. Additionally, at least one of the operations may be omitted, and other operations may be additionally performed.

Referring to FIG. 17, in operation 1710, a processor (e.g., the processor 512 of FIG. 5) of the wearable device 100 may determine a joint angle calibration value based on a joint angle of a user measured by an angle sensor (e.g., the first angle sensor 524 or the second angle sensor 524-1 of FIG. 5) of the wearable device 100. The processor may determine the joint angle calibration value by performing the operations described above with reference to FIGS. 12 to 16.

In operation 1720, the processor (comprising one or more processors, each including processing circuitry) may determine whether the set non-calibration condition is satisfied. The non-calibration condition may include, for example, a case where the walking speed of the user is less than a threshold value or a case where it is determined that the user has stopped walking, but embodiments are not limited thereto.

When the non-calibration condition is satisfied (e.g., when the walking speed of the user is less than the threshold value) (case of “Yes” in operation 1720), in operation 1730, the processor may control the torque output of the wearable device based on the joint angle measured by the angle sensor of the wearable device 100 without calibrating the joint angle.

When the non-calibration condition is not satisfied (e.g., when the walking speed of the user is not less than the threshold value) (case of “No” in operation 1720), in operation 1740, the processor may perform the calibration operation for the joint angle. For example, the processor may perform the operations described with reference to FIG. 15 or 16 to perform the calibration operation for the joint angle and determine the calibrated joint angle. Operation 1740 will be further described with reference to FIG. 18.

In operation 1750, the processor may control the torque output of the wearable device 100 based on the calibrated joint angle. The processor may determine a profile of torque (e.g., an output pattern of torque) to be output through a driving module (e.g., the driving module 530 or the driving module 530-1 of FIG. 5) of the wearable device 100 based on the calibrated joint angle.

FIG. 18 is a flowchart illustrating in more detail operations of calibrating a joint angle and controlling torque of the wearable device 100 based on the calibrated joint angle according to an example embodiment.

Referring to FIG. 18, in operation 1810, the wearable device 100 may determine the number of steps of a user wearing the wearable device 100 using sensor data obtained from a sensor (e.g., the IMU 522, the first angle sensor 524, or the second angle sensor 524-1 of FIG. 5) of the wearable device 100. For example, a walking pattern may be estimated from sensor data of an acceleration and/or angular velocity measured from an IMU of the wearable device 100, and the number of steps may be counted whenever the specific walking time point is detected in the estimated walking pattern. The method of counting the number of steps is not limited thereto.

In operation 1820, the wearable device 100 may track an angle range of a joint angle of the user based on the determined number of steps and the joint angle of the user measured by the wearable device 100. The wearable device 100 may determine an angle range of a change in a first joint angle corresponding to a motion of a right leg of the user and an angle range of a change in a second joint angle corresponding to a motion of a left leg of the user from a previously measured joint angle each time the number of steps changes. The wearable device 100 may extract extreme values of a joint angle from previously measured joint angle data each time the number of steps changes, and determine the angle range of the joint angle based on the extracted extreme values. The extreme values may include a maximum or large value and a minimum or small value. In an embodiment, the previously measured joint angle data may be data for the joint angle measured during an interval in which the number of steps immediately before a change in the number of steps is maintained.

In operation 1830, the wearable device 100 may determine the joint angle calibration value based on the tracked angle range. The wearable device 100 may determine an angle error based on the determined angle range of the joint angle, and determine the joint angle calibration value based on the angle error.

In an embodiment, the wearable device 100 may determine a first average value based on a maximum/large value and a minimum/small value extracted from an angle range of a joint angle of a first joint (e.g., a right hip joint) of the user. For example, an average value of the maximum value and the minimum value extracted from the angle range of one cycle for the joint angle of the first joint may be determined as the first average value. The wearable device 100 may determine a second average value based on a maximum value and a minimum value extracted from an angle range of a joint angle of a second joint (e.g., a left hip joint) of the user. For example, an average value of the maximum value and the minimum value extracted from the angle range of one cycle for the joint angle of the second joint may be determined as the second average value. The wearable device 100 may determine the angle error based on the first average value and the second average value.

In an embodiment, the wearable device 100 may determine an angle error for the joint angle of the first joint based on a result value obtained by subtracting the first average value from the second average value. For example, the result value obtained by subtracting the first average value from the second average value may be determined as the angle error for the joint angle of the first joint.

In an embodiment, the wearable device 100 may determine an angle error for the joint angle of the second joint based on a result value obtained by subtracting the second average value from the first average value. For example, the result value obtained by subtracting the second average value from the first average value may be determined as the angle error for the joint angle of the second joint.

In operation 1840, the wearable device 100 may determine a calibrated joint angle based on the measured joint angle and the determined joint angle calibration value. The wearable device 100 may determine a first joint angle calibration value dependent on the determined angle error for the joint angle of the first joint and a second joint angle calibration value dependent on the determined angle error for the joint angle of the second joint. The wearable device 100 may determine a calibrated joint angle for the first joint by adjusting the measured joint angle of the first joint based on the first joint angle calibration value. The wearable device 100 may determine a calibrated joint angle for the second joint by adjusting the measured joint angle of the second joint based on the second joint angle calibration value.

In operation 1850, the wearable device 100 may control the torque output of the wearable device 100 based on the calibrated joint angle. The wearable device 100 may control the torque output of a motor (e.g., the motor 534; 534-1 of FIG. 5) of the wearable device 100 based on the calibrated joint angle. Based on the calibrated joint angle, the intensity of torque and/or a time point of torque application may be determined.

An operating method of a wearable device 100 according to an embodiment may include determining 1810 a number of steps of a user wearing the wearable device 100 using sensor data obtained from a sensor of the wearable device 100, based on the determined number of steps and a joint angle of the user measured by the wearable device 100, tracking 1820 an angle range of the joint angle of the user, determining 1830 a joint angle calibration value based on the tracked angle range, determining 1840 a calibrated joint angle based on the measured joint angle and the determined joint angle calibration value, and controlling 1850 a torque output of the wearable device 100 based on the calibrated joint angle.

The tracking 1820 of the angle range of the joint angle may include determining an angle range of a change in a first joint angle corresponding to a motion of a right leg of the user and an angle range of a change in a second joint angle corresponding to a motion of a left leg of the user from a previously measured joint angle each time the number of steps changes.

The determining of the joint angle calibration value may include determining the joint angle calibration value based on the angle range of the change in the first joint angle and the angle range of the change in the second joint angle.

The tracking 1820 of the angle range of the joint angle may include extracting extreme values of a joint angle from previously measured joint angle data each time the number of steps changes, and determining the angle range of the joint angle based on the extracted extreme values.

The previously measured joint angle data may be data for joint angles measured during an interval in which the number of steps immediately before a change in the number of steps is maintained.

The determining 1830 of the joint angle calibration value may include determining an angle error based on the angle range of the joint angle, and determining the joint angle calibration value based on the angle error.

The determining of the angle error may include determining a first average value based on a maximum value and a minimum value extracted from an angle range of a joint angle of a first joint of the user, determining a second average value based on a maximum value and a minimum value extracted from an angle range of a joint angle of a second joint of the user, and determining the angle error based on the first average value and the second average value.

The determining of the angle error may include determining an angle error for the joint angle of the first joint based on a result value obtained by subtracting the first average value from the second average value, and determining an angle error for the joint angle of the second joint based on a result value obtained by subtracting the second average value from the first average value.

The determining 1830 of the joint angle calibration value may include determining the joint angle calibration value that makes the angle error zero.

The determining 1830 of the joint angle calibration value may include determining a first joint angle calibration value dependent on an angle error for the joint angle of the first joint of the user and a second joint angle calibration value dependent on an angle error for the joint angle of the second joint of the user.

The determining of the calibrated joint angle may include determining a calibrated joint angle for the first joint by adjusting the measured joint angle of the first joint based on the first joint angle calibration value, and determining a calibrated joint angle for the second joint by adjusting the measured joint angle of the second joint based on the second joint angle calibration value.

The determining of the calibrated joint angle may include determining the calibrated joint angle by adding the determined joint angle calibration value to the measured joint angle.

The determining 1810 of the number of steps of the user may include increasing the number of steps of the user when a signal value of a signal obtained from an IMU 135; 522 included in the wearable device 100 is greater than or equal to a threshold value.

A non-transitory computer-readable storage medium according to an embodiment may record instructions that, when executed by one or more processors 512, cause the one or more processors 512 to perform the operating method.

A wearable device 100 according to an embodiment may include a driving module 530; 530-1 including a motor 534; 534-1 and/or circuitry, a torque transmission frame 50; 55 configured to transmit torque generated by the motor 534; 534-1 to a leg of a user, a sensor including an angle sensor 125; 524; 524-1 configured to measure a joint angle of the user corresponding to an angle of the torque transmission frame 50; 55, and one or more processors 512 configured to calibrate the joint angle and control the motor 534; 534-1 based on the calibrated joint angle.

The one or more processors 512 may be configured to determine a number of steps of the user wearing the wearable device 100 using sensor data obtained from the sensor, based on the determined number of steps and a joint angle of the user measured by the wearable device 100, track an angle range of the joint angle of the user, determine a joint angle calibration value based on the tracked angle range, determine a calibrated joint angle based on the measured joint angle and the determined joint angle calibration value, and control a torque output of the motor 534; 534-1 based on the calibrated joint angle.

The one or more processors 512 may be configured to determine an angle range of a change in a first joint angle corresponding to a motion of a right leg of the user and an angle range of a change in a second joint angle corresponding to a motion of a left leg of the user from a previously measured joint angle each time the number of steps changes.

The one or more processors 512 may be configured to extract extreme values of a joint angle from previously measured joint angle data each time the number of steps changes, and determine the angle range of the joint angle based on the extracted extreme values.

The one or more processors 512 may be configured to determine an angle error based on the angle range of the joint angle, and determine the joint angle calibration value based on the angle error.

The one or more processors 512 may be configured to determine a first average value based on a maximum value and a minimum value extracted from an angle range of a joint angle of a first joint of the user, determine a second average value based on a maximum value and a minimum value extracted from an angle range of a joint angle of a second joint of the user, and determine the angle error based on the first average value and the second average value.

The one or more processors 512 may be configured to determine an angle error for the joint angle of the first joint based on a result value obtained by subtracting the first average value from the second average value, and determine an angle error for the joint angle of the second joint based on a result value obtained by subtracting the second average value from the first average value.

The one or more processors 512 may be configured to determine a first joint angle calibration value dependent on an angle error for the joint angle of the first joint of the user and a second joint angle calibration value dependent on an angle error for the joint angle of the second joint of the user, determine a calibrated joint angle for the first joint by adjusting the measured joint angle of the first joint based on the first joint angle calibration value, and determine a calibrated joint angle for the second joint by adjusting the measured joint angle of the second joint based on the second joint angle calibration value.

Various embodiments of calibrating the joint angle described above may be applied not only to a wearable device for leg assistance but also to a wearable device for upper limb assistance. At this time, the joint angle of an arm moving back and forth around a shoulder axis of a user may be calibrated.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via at least third component(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Accordingly, each “module” in the present disclosure may include a circuit. Thus, each “module” herein may comprise circuitry.

Software may include a computer program, a piece of code, an instruction, or one or more combinations thereof, to independently or collectively instruct or configure a processing device to operate as desired. Software and/or data may be embodied permanently or temporarily in any type of machine, component, physical or virtual equipment, or computer storage medium or device capable of providing instructions or data to or being interpreted by the processing device. The software also may be distributed over network coupled computer systems so that the software is stored and executed in a distributed fashion. The software and data may be stored by one or more non-transitory computer-readable recording media. Embodiments as set forth herein may be implemented as software including one or more instructions that are stored in a storage medium that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure exemplifies and describes with reference to various embodiments, it shall be construed that various embodiments are for the illustrative purpose rather than limiting. It shall be further understood by those skilled in the art that various changes in forms and details may be made without departing from the true spirit and full scope of this disclosure including the scope of the attached claims and their equivalents. In addition, it shall be construed that the embodiments described herein may be used with other embodiments of the present disclosure.

1. An operating method of a wearable device, the operating method comprising:
determining a number of steps of a user wearing the wearable device using sensor data obtained from at least a sensor of the wearable device;
based on the determined number of steps and a joint angle of the user measured by the wearable device, tracking an angle range of the joint angle of the user;
determining a joint angle calibration value based on the tracked angle range;
determining a calibrated joint angle based on the measured joint angle and the determined joint angle calibration value; and
controlling a torque output of the wearable device based on the calibrated joint angle.

2. The operating method of claim 1, wherein the tracking of the angle range of the joint angle comprises determining an angle range of a change in a first joint angle corresponding to a motion of a right leg of the user and an angle range of a change in a second joint angle corresponding to a motion of a left leg of the user from a previously measured joint angle each time the number of steps changes.

3. The operating method of claim 2, wherein the determining of the joint angle calibration value comprises determining the joint angle calibration value based on the angle range of the change in the first joint angle and the angle range of the change in the second joint angle.

4. The operating method of claim 1, wherein the tracking of the angle range of the joint angle comprises:
extracting extreme values of a joint angle from previously measured joint angle data each time the number of steps changes; and
determining the angle range of the joint angle based on the extracted extreme values.

5. The operating method of claim 4, wherein the previously measured joint angle data is data for joint angles measured during an interval in which the number of steps immediately before a change in the number of steps is maintained.

6. The operating method of claim 1, wherein the determining of the joint angle calibration value comprises:
determining an angle error based on the angle range of the joint angle; and
determining the joint angle calibration value based on the angle error.

7. The operating method of claim 6, wherein the determining of the angle error comprises:
determining a first average value based on a high value and a low value extracted from an angle range of a joint angle of a first joint of the user;
determining a second average value based on a high value and a low value extracted from an angle range of a joint angle of a second joint of the user; and
determining the angle error based on the first average value and the second average value.

8. The operating method of claim 7, wherein the determining of the angle error comprises:
determining an angle error for the joint angle of the first joint based on a result value obtained by subtracting the first average value from the second average value; and
determining an angle error for the joint angle of the second joint based on a result value obtained by subtracting the second average value from the first average value.

9. The operating method of claim 6, wherein the determining of the joint angle calibration value comprises determining the joint angle calibration value that makes the angle error zero.

10. The operating method of claim 6, wherein
the determining of the joint angle calibration value comprises determining a first joint angle calibration value dependent on an angle error for the joint angle of the first joint of the user and a second joint angle calibration value dependent on an angle error for the joint angle of the second joint of the user, and
the determining of the calibrated joint angle comprises:
determining a calibrated joint angle for the first joint by adjusting the measured joint angle of the first joint based on the first joint angle calibration value; and
determining a calibrated joint angle for the second joint by adjusting the measured joint angle of the second joint based on the second joint angle calibration value.

11. The operating method of claim 1, wherein the determining of the calibrated joint angle comprises determining the calibrated joint angle at least by adding the determined joint angle calibration value to the measured joint angle.

12. The operating method of claim 1, wherein the determining of the number of steps of the user comprises increasing the number of steps of the user when a signal value of a signal obtained from an inertial measurement unit (IMU) included in the wearable device is greater than or equal to a threshold value.

13. A wearable device comprising:
a driving module comprising a motor;
a torque transmission frame configured to transmit torque generated by the motor to a leg of a user;
a sensor, comprising an angle sensor, configured to measure a joint angle of the user corresponding to an angle of the torque transmission frame; and
one or more processors, comprising processing circuitry, individually and/or collectively configured to calibrate the joint angle and control the motor based on the calibrated joint angle,
wherein the one or more processors are individually and/or collectively configured to:
determine a number of steps of the user of the wearable device based on sensor data from the sensor;
based on the determined number of steps and a joint angle of the user, track an angle range of the joint angle of the user;
determine a joint angle calibration value based on the tracked angle range;
determine a calibrated joint angle based on the measured joint angle and the determined joint angle calibration value; and
control a torque of the motor based on the calibrated joint angle.

14. The wearable device of claim 13, wherein the one or more processors are individually and/or collectively configured to determine an angle range of a change in a first joint angle corresponding to a motion of a right leg of the user and an angle range of a change in a second joint angle corresponding to a motion of a left leg of the user from a previously measured joint angle each time the number of steps changes.

15. The wearable device of claim 13, wherein the one or more processors are individually and/or collectively configured to extract extreme values of a joint angle from previously measured joint angle data each time the number of steps changes, and determine the angle range of the joint angle based on the extracted extreme values.

16. The wearable device of claim 13, wherein the one or more processors are individually and/or collectively configured to determine an angle error based on the angle range of the joint angle, and determine the joint angle calibration value based on the angle error.

17. The wearable device of claim 16, wherein the one or more processors are individually and/or collectively configured to determine a first average value based on a high value and a low value extracted from an angle range of a joint angle of a first joint of the user, determine a second average value based on a high value and a low value extracted from an angle range of a joint angle of a second joint of the user, and determine the angle error based on the first average value and the second average value.

18. The wearable device of claim 17, wherein the one or more processors are individually and/or collectively configured to determine an angle error for the joint angle of the first joint based on a result value obtained by subtracting the first average value from the second average value, and determine an angle error for the joint angle of the second joint based on a result value obtained by subtracting the second average value from the first average value.

19. The wearable device of claim 16, wherein the one or more processors are individually and/or collectively configured to determine the joint angle calibration value that makes the angle error zero.

20. A non-transitory computer-readable storage medium storing instructions which, when executed by one or more processors, cause a wearable device to perform a method comprising:
determining a number of steps of a user wearing the wearable device using sensor data obtained from at least a sensor of the wearable device;
based on the determined number of steps and a joint angle of the user measured by the wearable device, tracking an angle range of the joint angle of the user;
determining a joint angle calibration value based on the tracked angle range;
determining a calibrated joint angle based on the measured joint angle and the determined joint angle calibration value; and
controlling a torque output of the wearable device based on the calibrated joint angle.
